(19) United States
(12) Patent Application Publication
(10) Pub. No.: US 2026/0330026 A1
(43) Pub. Date: Oct. 22, 2026

(54) SYSTEM

(71) Applicant: SoftBank Group Corp., Tokyo (JP)

(72) Inventor: Megumi NAGANO, Tokyo (JP)

(73) Assignee: SoftBank Group Corp., Tokyo (JP)

(21) Appl. No.: 19/647,955

(22) Filed: Apr. 15, 2026

(30) Foreign Application Priority Data
Apr. 22, 2025 (JP) 2025-070593

(51) Int. Cl. G06F 21/57

(52) U.S. Cl. CPC G06F 21/577; G06F 2221/034

(57) ABSTRACT

The present invention relates to a system comprising an information collection unit, an information analysis unit, a business support unit, and a creativity support unit, and configured to automatically collect information from various external and internal information sources utilizing a generative AI, execute summarization, keyword extraction, trend analysis, risk evaluation, and the like by natural language processing, and comprehensively and automatically realize decision-making support, business efficiency improvement, and creativity improvement. Simply by inputting a theme or a condition from a terminal, a user can centrally receive information collection, analysis, presentation of a decision-making plan, automation of routine work, idea support, and the like, making it possible to reduce a business burden and maximize productivity and creativity.

### CROSS-REFERENCE TO RELATED APPLICATION

The present application claims priority to and incorporates by reference the entire contents of Japanese Patent Application No. 2025-070593 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is the problem that it takes a great deal of time and effort to access and analyze necessary information due to information overload faced by modern busy businesspersons, the problem that the burden of information collection and analysis necessary for decision-making is increasing due to increasingly complex and sophisticated business, the problem that it is difficult to quickly and accurately grasp the latest technology and market trends, the problem that a lot of time is taken up by daily routine work despite wanting to concentrate on creative work and core work, furthermore the problem that it is difficult to cross-sectionally and efficiently collect and analyze internal and external information due to fragmentation and diversification of information, and the problem that productivity and creativity of businesspersons cannot be sufficiently exhibited because a mechanism for centrally and automatically supporting a plurality of business processes such as information collection, analysis, decision-making, business efficiency improvement, and creativity improvement does not conventionally exist, and in order to solve these problems, an object of the present invention is to provide a system that comprehensively and automatically realizes information collection, analysis, decision-making support, business efficiency improvement, and creativity improvement utilizing a generative AI.

### SUMMARY OF THE INVENTION

As a means for solving the problems, a system comprising an information collection unit, an information analysis unit, a business support unit, and a creativity support unit is configured, wherein the information collection unit has a function of automatically and cross-sectionally collecting related information from a plurality of information sources such as an external web search engine, a news distribution service, an internal database, an email server, a file server, and a scheduler based on a keyword or a business theme specified by a user, and centrally storing the collected information; the information analysis unit has a function of executing analysis processing such as automatic summarization, important point extraction, trend analysis, keyword extraction, and risk evaluation on the information acquired by the collection unit by a natural language processing technology using a generative AI, and outputting an analysis result in a visually easy-to-understand format; the business support unit has a function of automatically generating a plurality of options for decision-making related to a business of the user based on an output result of the analysis unit, calculating a risk score and advantages and disadvantages referring to past cases and statistical data for each of the options, and presenting an optimal option as a recommended plan, and further has a function of automating routine work such as schedule adjustment, email reply, meeting minutes creation, ToDo list generation, and business trip arrangement; the creativity support unit has a function of automatically generating examples of different industries, application examples of the latest technology, idea support phrases, question examples prompting free ideas, and the like using the generative AI, and providing information and hints for promoting creative thinking and new idea creation of the user; and these units operate in cooperation with each other to finally automatically generate and provide to the user a report integrating an information collection result, an analysis result, decision-making support content, business efficiency improvement progress, and creativity improvement support content.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

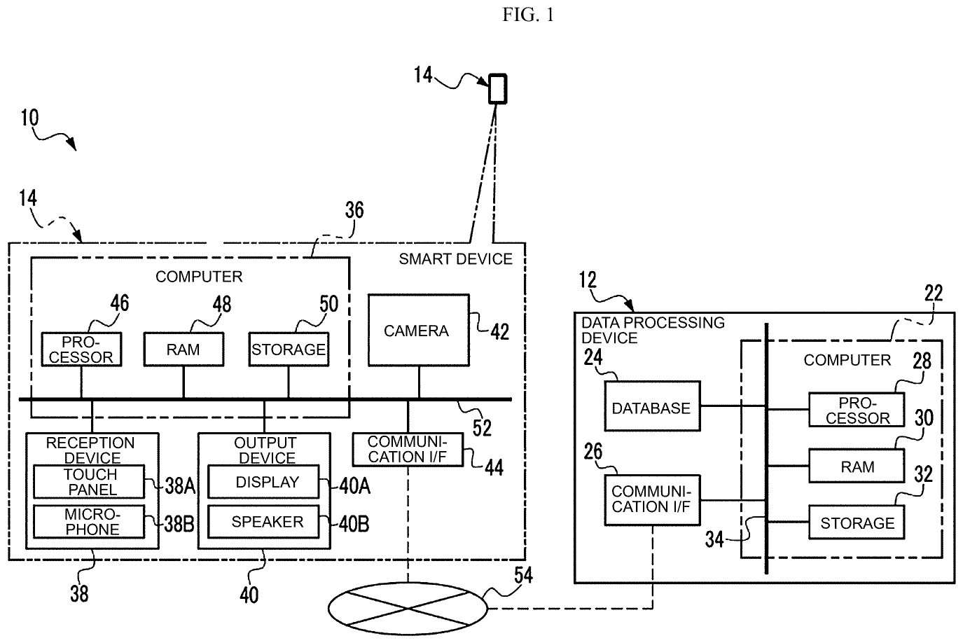

FIG. 1 Shows an Example Configuration of a Data Processing System 10 According to

the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

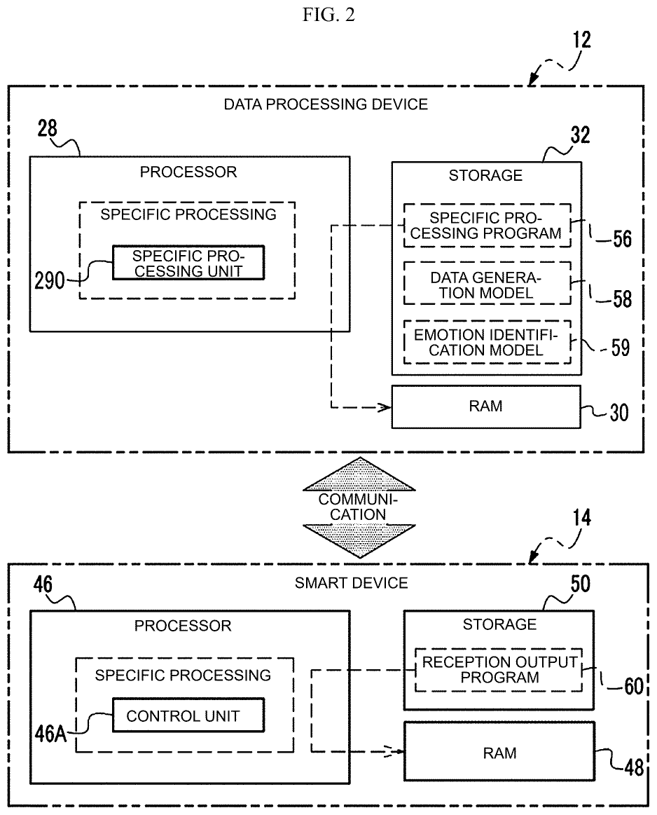

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying out the Present Invention)

Embodiments for carrying out the present invention will be described exhaustively, in detail, and with depth, with further increased specificity.

The system of the present invention is composed of a server and a terminal, and is configured such that main processing of an information collection unit, an information analysis unit, a business support unit, and a creativity support unit is executed on the server side, and a user interface and operations such as input, confirmation, editing, and approval by a user are realized on the terminal side. The server can be constructed in a cloud environment or an on-premises environment, and various devices capable of network connection, such as a personal computer, a tablet terminal, a smartphone, and a wearable terminal, can be used as the terminal. Specifically, the present system adopts a distributed computing architecture. The present server includes a parallel processing cluster composed of a plurality of computing nodes. The present server includes a hardware accelerator dedicated to tensor operations in order to speed up inference processing of a large language model. The present terminal executes asynchronous communication with the present server via a secure communication protocol. The present system vectorizes input data of the user and transmits the vectorized input data to the present server. The present server processes the received vector data in a high-dimensional space. With this configuration, the present system minimizes a calculation load on the terminal side. The present system executes advanced natural language processing in real time by utilizing massive computing resources on the server side. The present system implements a prefetch algorithm for hiding communication delay. The present system applies a data compression module in order to reduce consumption of a network bandwidth. The present system also includes a variation in which a part of the inference processing is executed on the terminal side by using edge computing technology together. Thereby, the present system provides a minimum business support function even in an offline environment. The present system enables a completely closed network deployment in an on-premises environment in a use case where high security is required, such as a financial institution or a medical institution. Thereby, the present system physically blocks a risk of external leakage of confidential data. In a cloud environment, the present system dynamically scales resources according to a load using container orchestration technology. Thereby, the present system maintains stable response performance even during sudden access concentration.

First, a specific configuration of the information collection unit will be described. The information collection unit receives a keyword or a business theme input from the terminal by the user, for example, “latest trends in generative AI”, “sustainability in the automobile industry”, “regulatory trends in the European market”, “examples of launching new businesses”, “M&A trends of competitors”, and the like, and accesses a plurality of external and internal information sources on the server. The external information sources include a web search engine API, a news distribution service API, a paper database API, a patent database API, an SNS public information API, and the like. For example, articles and white papers related to “latest trends in generative AI” are collected using the web search engine API, the latest academic papers related to “sustainability in the automobile industry” are acquired using the paper database API, and expert posts and discussions related to “regulatory trends in the European market” are collected using the SNS public information API. The internal information sources include an internal database API, an email server API, a file server API, a scheduler API, an internal chat API, an internal project management system API, and the like. For example, past project materials and reports related to “examples of launching new businesses” are searched using the internal database API, internal emails and attached files related to “M&A trends of competitors” are acquired using the email server API, and related meeting schedules and task information are acquired using the scheduler API. These pieces of information are centrally stored in a database on the server, and deduplication of information and metadata addition (acquisition date and time, information source, related keyword, etc.) are also automatically performed. Specifically, the present information collection unit inputs the input natural language query into a pre-trained transformer model. The present transformer model converts the input query into a 768-dimensional dense vector. The present information collection unit executes a similarity search on a vector database using this dense vector. The present information collection unit dynamically generates an optimal search query for each API based on a search result. The present information collection unit transmits requests in parallel to a plurality of APIs using asynchronous IO. The present information collection unit parses unstructured data in a JSON format or an XML format returned from each API. The present information collection unit executes morphological analysis and named entity extraction on the acquired text data. The present information collection unit constructs a knowledge graph using the extracted entities as nodes and relationships as edges. The present information collection unit expands the acquired data group on a memory as a multidimensional tensor. The present information collection unit applies clustering based on cosine similarity to this tensor. The present information collection unit mathematically detects and eliminates duplication of information using this clustering result. The present information collection unit calculates a reliability score of each information source as metadata. The present information collection unit calculates this reliability score using a variant of a PageRank algorithm. The present information collection unit normalizes a timestamp of the acquired text and stores it as a time-series array. The present information collection unit generates a structured data set that is easy for a subsequent AI model to process by these pre-processes. Thereby, the present information collection unit significantly reduces noise data. The present information collection unit prevents waste of computing resources and dramatically improves processing efficiency of the entire system. The present information collection unit provides a foundation for instantly extracting truly valuable information from a vast amount of information sources in use cases such as patent infringement investigation in a legal department of a company and competitor analysis in a marketing department.

Next, a specific configuration of the information analysis unit will be described. The information analysis unit applies a natural language processing technology and a machine learning technology utilizing a generative AI to a wide variety of information collected by the information collection unit. For example, using an automatic summarization function by the generative AI, only important points and conclusions are extracted from a long paper, report, news article, internal report, meeting minutes, and the like, and a summary sentence of several lines is generated. For example, a summary such as “From 2024 onwards, the share of electric vehicles will rapidly expand in the European market, and stricter regulations are the main factor” is automatically generated from a 10-page market research report. Using a keyword extraction function by the generative AI, frequently appearing keywords and topics are automatically extracted from a plurality of news articles and internal materials, and trend words such as “carbon neutral”, “stricter regulations”, “emerging markets”, and “AI utilization” are listed, for example. Using a trend analysis function by the generative AI, changes in topics over time and common points and differences among a plurality of information sources are extracted, and an analysis result such as “topics related to ‘generative AI’ have rapidly increased since the latter half of 2023” and “there is a difference in regulatory trends between Europe and North America” is output, for example. Using a risk evaluation function by the generative AI, past failure cases and trouble cases related to “launching a new business”, for example, are analyzed, risk factors such as “non-compliance with laws and regulations at the time of market entry is a main risk” and “lack of grasping trends of competitors is a failure factor” are extracted, and a risk score is calculated. The analysis result is automatically generated in a visual format such as text, a graph, a chart, a heat map, and a word cloud that is intuitively easy for the user to understand, using a natural language generation function by the generative AI. For example, trends extracted from a plurality of market trend reports can be displayed in a time-series graph, a risk evaluation result can be visualized in a heat map, and an appearance frequency of keywords can be shown in a word cloud. Specifically, the present information analysis unit includes a large language model with a scale of billions of parameters equipped with a self-attention mechanism as a core. The present information analysis unit instructs a specific task to this large language model using a prompt engineering technology. The present information analysis unit receives a text sequence of up to 8192 tokens as input data. The present information analysis unit converts this text sequence into an array of integers by a tokenizer. The present information analysis unit maps this integer array to a continuous vector space through an embedding layer. The present information analysis unit utilizes an encoder-decoder architecture in an automatic summarization task. The present information analysis unit extracts a feature vector with the largest amount of information from a latent representation of the input text. The present information analysis unit generates an optimal summary text from this feature vector using a beam search algorithm. The present information analysis unit adopts a hybrid method combining a TF-IDF algorithm and a weight of self-attention in a keyword extraction task. The present information analysis unit inputs time-series data to a recurrent neural network or a one-dimensional convolutional neural network in a trend analysis task. The present information analysis unit outputs a future trend fluctuation probability from this network. The present information analysis unit uses a classification model trained on past incident data in a risk evaluation task. The present information analysis unit inputs a plan text of a target project to this classification model. The present information analysis unit outputs a risk score, which is a continuous value in a range of 0.0 to 1.0, from this classification model. The present information analysis unit sets an alert flag when this risk score exceeds a preset threshold value. The present information analysis unit transmits this alert flag to the subsequent business support unit. The present information analysis unit formats an output result as a structured JSON object. The present information analysis unit passes this JSON object to a drawing library of a front end. By this processing, the present information analysis unit completes reading and analysis of a vast amount of documents, which would take a human several days, in a few seconds. The present information analysis unit provides an objective data-driven insight eliminating human cognitive bias. The present information analysis unit exhibits extremely high usefulness in use cases such as corporate value evaluation in an investment bank and supply chain risk management in a manufacturing industry.

A specific configuration of the business support unit will be described. The business support unit is realized by sharing functions between both the server and the terminal. On the server side, based on an output result of the information analysis unit, a plurality of options for decision-making related to a business of the user are automatically generated using the generative AI. For example, options such as “utilization of existing technology”, “cooperation with external partners”, and “introduction of new technology” are generated as a “progress method of a new project”, and for each of them, the generative AI refers to past cases and statistical data, and automatically calculates a risk score and advantages and disadvantages. For example, evaluations such as “introduction cost is low but market differentiation is difficult” for “utilization of existing technology” and “superiority in the market is high but development risk is high” for “introduction of new technology” are automatically generated. Furthermore, automation is realized by utilizing the generative AI also for routine work such as schedule adjustment, email reply, meeting minutes creation, ToDo list generation, and business trip arrangement. For example, in schedule adjustment, schedules of related parties are automatically collated on the server, an optimal meeting date and time is proposed, and the user confirms and approves it on the terminal side. In email reply, content of a received email is analyzed on the server, the generative AI creates an email reply template, and the user confirms and edits the content on the terminal side and transmits it. For example, a reply text such as “Thank you for contacting us. We will check the matter you pointed out with the department in charge and contact you again” is automatically generated for a common inquiry email. In meeting minutes creation, audio data of a web conference is uploaded to the server, the generative AI automatically performs transcription and important point extraction, and the user confirms and corrects the minutes on the terminal side. For example, a summary is automatically generated for each item such as “project progress report”, “issues”, and “next action” from remarks in the meeting. In ToDo list generation, tasks are extracted from emails and schedules on the server, priorities and deadlines are automatically assigned to list them, and the user manages the tasks on the terminal side. For example, tasks such as “submit a market research report by next week” and “prepare meeting materials at 10:00 tomorrow” are automatically generated. In business trip arrangement, optimal transportation means and accommodations are automatically searched and reserved on the server based on a destination and a schedule, and the user performs final confirmation on the terminal side. For example, processing such as “automatically reserve a Shinkansen and a hotel in accordance with a business trip to Osaka next week” is realized. Specifically, the present business support unit includes a decision-making support agent based on reinforcement learning. The present business support unit inputs the risk score and a trend vector output from the information analysis unit to this agent as a state space. The present business support unit outputs a plurality of strategic options defined as an action space from this agent. The present business support unit applies a Monte Carlo tree search algorithm to each option. The present business support unit calculates an expected reward value of each option by this search. The present business support unit ranks the options based on this expected reward value. The present business support unit utilizes a solver of a constraint satisfaction problem in a schedule adjustment function. The present business support unit inputs a free time vector of participants and an availability matrix of meeting rooms to this solver. The present business support unit outputs a combination of optimal time frames satisfying all constraints from this solver. The present business support unit adopts a sequence-to-sequence model in an email reply function. The present business support unit inputs a text tensor of a received email to this model. The present business support unit outputs a probability distribution of a reply text from this model and samples a word string with the highest probability. The present business support unit uses an acoustic model combining a convolutional neural network for speech recognition and a transformer in a meeting minutes creation function. The present business support unit inputs a speech feature tensor converted into Mel-frequency cepstral coefficients to this acoustic model. The present business support unit outputs a sequence of utterance text from this acoustic model. The present business support unit further inputs this text sequence to a summarization model to generate structured minutes data. The present business support unit extracts a deadline and a person in charge from text using a named entity extraction model in a ToDo list generation function. The present business support unit inserts this extraction result into a task table of a relational database. By these processes, the present business support unit completely automates a business process while minimizing human intervention. The present business support unit eliminates human errors and dramatically improves a processing speed of business. The present business support unit dramatically improves business efficiency in use cases such as automation of customer response in a sales department and interview scheduling in a human resources department.

A specific configuration of the creativity support unit will be described. The creativity support unit is mainly realized on the server side, automatically collects and analyzes, for example, successful examples of different industries, application examples of the latest technology, past innovation examples, and the like using the generative AI, and generates optimal information and hints in accordance with an interest field and a business theme of the user. For example, examples of different industries such as “examples of introducing a subscription model in the food industry”, “examples of utilizing AI in the construction industry”, and “remote diagnosis technology in the medical field” are automatically presented according to the industry and interest of the user. Furthermore, using an idea support phrase generation function by the generative AI, question examples prompting free ideas and phrases such as “what happens if this issue is considered from the perspective of a completely different industry?”, “let's think of a new combination without being bound by an existing framework”, and “let's remove all current constraints once and think freely” are automatically generated and presented to the user on the terminal side. Furthermore, specific hints and information for promoting creative thinking, such as “brainstorming support for new business ideas”, “extraction of differentiation points of existing services”, and “prediction of future market needs”, can also be automatically generated using the generative AI. Specifically, the present creativity support unit includes an analogy inference engine utilizing vector operations in a latent space. The present creativity support unit inputs a feature vector representing a current business domain of the user to this inference engine. The present creativity support unit shifts the vector in a direction orthogonal to this feature vector or a direction in which noise is intentionally added. The present creativity support unit executes a neighborhood search on a knowledge graph using this shifted vector. The present creativity support unit extracts a concept node of a different industry that is semantically distant but structurally similar by this search. The present creativity support unit inputs attribute data of this concept node to a large language model. The present creativity support unit outputs an idea text translated so as to fit the domain of the user from this large language model. The present creativity support unit intentionally sets a temperature parameter for controlling diversity of prompts high in an idea support phrase generation function. By this setting, the present creativity support unit avoids a deterministic output and generates an accidental phrase with high randomness. The present creativity support unit applies a concept of a generative adversarial network in a brainstorming support function. The present creativity support unit causes one model to generate an idea and causes another model to point out a weakness or a contradiction of the idea. The present creativity support unit structures a dialogue log between these two models and presents it to the user. The present creativity support unit uses a graph neural network trained on time-series transitions of patent data and paper data over the past several decades in a future market needs prediction function. The present creativity support unit outputs a prediction probability distribution of a technology trend 5 years or 10 years later from this network. The present creativity support unit breaks down human stereotypes by these unconventional algorithms. The present creativity support unit realizes true knowledge creation based on mathematical operations in a high-dimensional space, rather than mere information retrieval. The present creativity support unit significantly increases a probability of creating innovation in use cases such as search for new materials in a research and development department and new product development in a planning department.

Finally, these units operate in cooperation with each other, automatically generate a report integrating an information collection result, an analysis result, decision-making support content, business efficiency improvement progress, and creativity improvement support content on the server side, and present the report to the user through an easy-to-understand interface on the terminal side. For example, it can be configured such that a latest market trend summary, a recommended decision-making plan, an ongoing business efficiency improvement task, and a hint for creativity improvement can be confirmed at a glance on a dashboard screen on the terminal side. Furthermore, a function allowing the user to input a comment or feedback on report content, a sharing function for sharing the report content with other related parties, a function of automatically generating a new task or meeting based on the report content, and the like can also be realized on the terminal side. Specifically, the present system implements an event-driven message broker for integrating asynchronous data streams output from the respective units. The present system realizes loosely coupled communication between respective modules via this message broker. The present system uses a rendering engine that dynamically constructs a document object model in an integrated report generation function. The present system inputs JSON data from the respective units to this engine. The present system outputs an interactive web page formatted in HTML5 and CSS3 from this engine. The present system establishes bidirectional communication using a WebSocket protocol on the dashboard screen. By this communication, the present system reflects data update on the server side on the screen on the terminal side in real time. The present system accumulates feedback input from the user as a data set for retraining a natural language processing model. The present system periodically executes fine tuning for finely adjusting a weight parameter of the model using this feedback data. The present system applies fine-grained authority management based on an access control list in the sharing function. The present system cryptographically prevents unauthorized viewing of confidential information by this authority management. The present system utilizes an ensemble of a rule-based parser and a machine learning model that extracts an action item from text in the report in an automatic generation function of a new task. The present system constructs a dependency graph of tasks from this ensemble output. The present system transmits this graph to an API of a project management tool. The present system prevents information silos by these integration processes. The present system reduces a cognitive load on the user and shortens a lead time from decision-making to execution to the utmost limit. The present system dramatically improves productivity of the entire organization in use cases such as an integrated dashboard for management and a progress management portal for project managers.

In addition, utilization of the generative AI is specifically applied one by one in each unit. For example, in the information collection unit, relevance determination and noise removal of information to be collected are performed using the generative AI, and in the information analysis unit, multilingual translation, summarization, sentiment analysis, causal relationship extraction, scenario generation, and the like by the generative AI are executed. In the business support unit, automatic generation of a decision-making plan, automatic generation of a risk scenario, personalized proposal based on a past decision-making tendency of the user, automatic generation of email text and minutes, automatic classification and prioritization of tasks, and the like by the generative AI are performed. In the creativity support unit, idea generation support, automatic extraction of examples of different industries, automatic generation of a future prediction scenario, automatic generation of a prompt for brainstorming, and the like by the generative AI are realized. Furthermore, it is also possible to utilize a business history and past decision-making data of the user as learning data to increase output accuracy and a personalization degree of the generative AI. For example, a proposal or a summary more optimized for the user can be generated based on a decision-making plan selected by the user in the past or a description tendency of past minutes. Specifically, the present system adopts a model routing architecture that dynamically switches and uses a plurality of specialized neural network models optimized for respective functional requirements. The present system uses a binary classifier obtained by fine-tuning a pre-trained language model in the information collection unit. The present system inputs scraped text to this classifier and causes it to output a relevance score. The present system utilizes a multilingual transformer model in the information analysis unit. The present system inputs a text tensor of a foreign language to this model and causes it to output a translated text tensor of a native language. The present system applies a regression model that outputs polarity of text as a continuous value from minus 1 to plus 1 in a sentiment analysis task. The present system extracts a pair of a cause node and a result node using a dependency structure analysis algorithm in a causal relationship extraction task. The present system handles a past action log of the user as sequence data in the business support unit. The present system inputs this sequence data to a long short-term memory network. The present system outputs a probability distribution of an action to be taken next by the user from this network. The present system generates a personalized proposal based on this probability distribution. The present system learns a latent space of ideas using a variational autoencoder in the creativity support unit. The present system generates a novel idea text by decoding a vector randomly sampled from this latent space. The present system implements a reinforcement learning loop using feedback of the user as a reward signal. By this loop, the present system continuously updates a policy of the model using a proximal policy optimization algorithm. The present system monotonically increases inference accuracy of the system over time by this continuous learning mechanism. The present system overcomes limitations of a general-purpose AI model and acquires high expertise specialized in a specific business domain. The present system brings an overwhelming competitive advantage in use cases such as uniformization of response quality in customer support and automatic generation of personalized advertisements in marketing.

As described above, in the embodiment of the present invention, by adopting a configuration in which the respective units of the information collection unit, the information analysis unit, the business support unit, and the creativity support unit are mainly realized on the server side, and a user interface and operations such as final confirmation, editing, and approval are realized on the terminal side, it becomes possible to comprehensively and automatically support information collection, analysis, decision-making, business efficiency improvement, and creativity improvement while maximizing utilization of the generative AI and significantly reducing a business burden on the user. For example, a personal computer, a tablet terminal, a smartphone, or the like can be used as the terminal, and the server can be constructed in a cloud environment or an on-premises environment. As the generative AI, a large language model, an image generation model, a speech recognition model, or the like operating on the server can be used, and is utilized one by one in each processing such as natural language summarization, keyword extraction, risk evaluation, decision-making support, idea support phrase generation, automatic minutes creation, automatic email reply, and task extraction, for example. Furthermore, it is also possible to utilize a business history and past decision-making data of the user as learning data to increase output accuracy and a personalization degree of the generative AI. For example, a proposal or a summary more optimized for the user can be generated based on a decision-making plan selected by the user in the past or a description tendency of past minutes. Thereby, the system of the present invention can function as an advanced business support and creativity support platform with the generative AI as a core, beyond a conventional mere information retrieval or business automation tool. Specifically, the present system constructs a hybrid processing pipeline fusing edge computing and cloud computing in order to maximize advantages of a client-server model. The present system executes a lightweight inference model on the terminal side and performs real-time input completion and simple error checking. The present system drives a huge neural network with a scale of hundreds of billions of parameters on a parallel computing cluster using GPUs on the server side. The present system provides an AI inference result with the highest accuracy to the user while minimizing an influence of network delay by this role sharing. The present system adopts a diffusion model as an image generation model. The present system inputs a text prompt to this diffusion model and outputs a high-resolution image tensor through a noise removal process. The present system automatically inserts this image tensor as an illustration of presentation materials. The present system uses a recurrent neural network trained using a connectionist temporal classification loss as a speech recognition model. The present system realizes highly accurate transcription even in a noisy environment by this network. The present system stores an operation history of the user in a graph database. The present system applies a random walk algorithm to this graph data to extract a latent preference vector of the user. The present system injects this preference vector into a large language model as a context of a prompt. The present system significantly improves performance of zero-shot learning by this context injection. The present system fundamentally redefines human intellectual labor by integrating these advanced computer science methods. The present system establishes a foundation for new value creation through cooperation between humans and computers, rather than mere substitution of work. The present system functions as a core of an enterprise architecture promoting company-wide digital transformation and drives innovation of business processes in all industrial fields.

### (System Configuration)

The system according to the present embodiment includes an information collection unit, an information analysis unit, a business support unit, a creativity support unit, a user interface unit, a database management unit, and a security management unit. The information collection unit receives a keyword or a business theme input from a terminal by a user, for example, “latest trends in generative AI”, “sustainability in the automobile industry”, “regulatory trends in the European market”, “examples of launching new businesses”, “M&A trends of competitors”, and the like, accesses external information sources such as an external web search engine API, a news distribution service API, a paper database API, a patent database API, and an SNS public information API on a server, further accesses internal information sources such as an internal database API, an email server API, a file server API, a scheduler API, an internal chat API, and an internal project management system API, and automatically and cross-sectionally collects related information. For example, the information collection unit collects articles and white papers related to “latest trends in generative AI” using the web search engine API, acquires the latest academic papers related to “sustainability in the automobile industry” using the paper database API, collects expert posts and discussions related to “regulatory trends in the European market” using the SNS public information API, searches for past project materials and reports related to “examples of launching new businesses” using the internal database API, and acquires internal emails and attached files related to “M&A trends of competitors” using the email server API. The information collection unit centrally stores these pieces of information in a database on the server, and also automatically performs deduplication of information and metadata addition (acquisition date and time, information source, related keyword, etc.). Specifically, the system adopts a microservices architecture and deploys each unit as an independent container. The system realizes independent scaling and fault isolation of each functional module by this architecture. The information collection unit incorporates a distributed crawler engine. The information collection unit inputs a list of seed URLs and a parameter of a crawl depth to the crawler engine. The information collection unit outputs a stream of HTML documents from the crawler engine. The information collection unit applies a regular expression-based parser and a machine learning-based DOM tree analyzer to the stream. The information collection unit extracts structured data such as body text and an image link by this analysis. The information collection unit executes secure token authentication using an OAuth 2.0 protocol in accessing the internal information source. The information collection unit acquires data only within a range of an access authority of the user by this authentication. The information collection unit applies a locality-sensitive hashing algorithm to the acquired text data. The information collection unit calculates a fingerprint of the text by this algorithm. The information collection unit detects and eliminates a near-duplicate document at high speed by comparing a Hamming distance between the fingerprints. The information collection unit extracts an organization name, a person's name, and a place from the text using a named entity recognition model in the metadata addition. The information collection unit saves the extracted entity as metadata in an index column of a relational database. The information collection unit prevents waste of computational resources in a subsequent analysis phase by these advanced data pipeline processes. The information collection unit mathematically guarantees quality and consistency of data. The information collection unit provides a foundation for extracting a valuable signal from a vast data lake in real time in a use case such as large-scale market research or compliance violation monitoring.

The information analysis unit applies a natural language processing technology and a machine learning technology utilizing a generative AI to a wide variety of information collected by the information collection unit. For example, using an automatic summarization function by the generative AI, only important points and conclusions are extracted from a long paper, report, news article, internal report, meeting minutes, and the like, and a summary sentence of several lines is generated. For example, a summary such as “From 2024 onwards, the share of electric vehicles will rapidly expand in the European market, and stricter regulations are the main factor” is automatically generated from a market research report spanning 10 pages. Using a keyword extraction function by the generative AI, frequently appearing keywords and topics are automatically extracted from a plurality of news articles and internal materials, and trend words such as “carbon neutral”, “stricter regulations”, “emerging markets”, and “AI utilization” are listed, for example. Using a trend analysis function by the generative AI, changes in topics over time and commonalities and differences among a plurality of information sources are extracted, and an analysis result such as “topics related to ‘generative AI’ have rapidly increased since the latter half of 2023” and “there is a difference in regulatory trends between Europe and North America” is output, for example. Using a risk evaluation function by the generative AI, past failure cases and trouble cases related to “launching a new business”, for example, are analyzed, risk factors such as “non-compliance with laws and regulations at the time of market entry is a main risk” and “lack of grasping trends of competitors is a failure factor” are extracted, and a risk score is calculated. The analysis result is automatically generated in a visual format such as text, a graph, a chart, a heat map, and a word cloud that is intuitively easy for the user to understand, using a natural language generation function by the generative AI. For example, trends extracted from a plurality of market trend reports can be displayed in a time-series graph, a risk evaluation result can be visualized in a heat map, and an appearance frequency of keywords can be shown in a word cloud. Specific examples of a prompt sentence to be read by the generative AI include “Please summarize the following plurality of market research reports and extract major trends and risk factors”, “Please summarize the content of these meeting minutes in three lines and list action items for the next time”, “Please extract important tasks from the following email body and arrange them in order of priority”, and the like. Specifically, the information analysis unit implements a sliding window method of dividing processing according to a length of an input text. The information analysis unit avoids a context window limitation of a large language model by this method. The information analysis unit independently vectorizes each divided text chunk. The information analysis unit applies attention pooling to the vector group to synthesize a representation vector of the entire document. The information analysis unit inputs the representation vector to a decoder network and outputs an abstractive summary text. The information analysis unit executes topic modeling using latent Dirichlet allocation in keyword extraction. The information analysis unit outputs a matrix of a topic distribution probability of each document and a word appearance probability of each topic by this modeling. The information analysis unit selects a word group having the highest degree of contribution as trend words from a result of this matrix operation. The information analysis unit uses a dynamic time warping algorithm in trend analysis. The information analysis unit corrects a phase shift of time-series data between different information sources and accurately calculates a correlation by this algorithm. The information analysis unit applies a binary classifier using a support vector machine in risk evaluation. The information analysis unit inputs a pair of a text feature amount and a success/failure label of a past project as learning data to the classifier. The information analysis unit outputs a probability that a new project belongs to a failure class as a risk score from the classifier. The information analysis unit maps the risk score to a color code to generate a pixel value of a heat map. The information analysis unit uses a template engine in generating a prompt sentence. The information analysis unit binds a dynamic variable to the engine to construct a system prompt. The information analysis unit realizes quantitative analysis excluding human subjectivity by these non-conventional algorithms. The information analysis unit dramatically improves accuracy and throughput of data processing. The information analysis unit strongly supports data-driven decision-making in a use case such as credit examination in a financial institution or quality anomaly detection in a manufacturing industry.

The business support unit automatically generates a plurality of options for decision-making related to a business of the user using the generative AI based on an output result of the information analysis unit, automatically calculates a risk score and advantages and disadvantages referring to past cases and statistical data for each of the options, and presents an optimal option as a recommended plan. For example, options such as “utilization of existing technology”, “cooperation with external partners”, and “introduction of new technology” are generated as a “method of proceeding with a new project”, and evaluations such as “introduction cost is low but market differentiation is difficult” and “superiority in the market is high but development risk is high” are automatically generated for each of the options. Furthermore, routine work such as schedule adjustment, email reply, meeting minutes creation, ToDo list generation, and business trip arrangement is also automated utilizing the generative AI. For example, in schedule adjustment, schedules of related parties are automatically collated, an optimal meeting date and time is proposed, and the user confirms and approves it. In email reply, content of a received email is analyzed, the generative AI creates an email reply template, and the user confirms and edits the content and sends it. For example, a reply text such as “Thank you for contacting us. We will check the matter you pointed out with the department in charge and contact you again” is automatically generated for a common inquiry email. In meeting minutes creation, audio data of a web meeting is uploaded, the generative AI automatically performs transcription and important point extraction, and the user confirms and corrects the minutes. For example, a summary is automatically generated for each item such as “project progress report”, “issues”, and “next action” from statements in the meeting. In ToDo list generation, tasks are extracted from emails and schedules, priorities and deadlines are automatically assigned and listed, and the user manages the tasks. For example, tasks such as “submit a market research report by next week” and “prepare meeting materials at 10:00 tomorrow” are automatically generated. In business trip arrangement, an optimal transportation means and accommodation are automatically searched and reserved based on a destination and a schedule, and the user performs final confirmation. For example, processing such as “automatically reserve a bullet train and a hotel for a business trip to Osaka next week” is realized. Specific examples of a prompt sentence to be read by the generative AI include “Please transcribe the following meeting audio data and summarize important points for each speaker”, “Please generate an appropriate reply text to the content of this email”, “Please create a ToDo list from the following schedule and email content”, and the like. Specifically, the business support unit implements an inference engine based on a Markov decision process. The business support unit inputs a current business state vector and a target state vector to the inference engine. The business support unit outputs an optimal action policy from the inference engine using a state transition probability matrix and a reward function. The business support unit decodes the action policy into a natural language to generate a plurality of option texts. The business support unit calculates a similarity score for each option from a database of past similar cases using a K-nearest neighbor algorithm. The business support unit extracts texts of advantages and disadvantages using the similarity score as a weight. The business support unit applies an algorithm of a graph coloring problem in schedule adjustment. The business support unit allocates a minimum time slot from a graph having participants as nodes and schedule conflicts as edges by this algorithm. The business support unit uses a few-shot prompting technology in email reply. The business support unit controls a tone and manner of an output text by including several past excellent reply examples in a prompt by this technology. The business support unit applies a speaker diarization model in meeting minutes creation. The business support unit inputs an audio waveform tensor to the model and outputs a probability distribution of which speaker each frame belongs to. The business support unit assigns a speaker label to a transcribed text using the probability distribution. The business support unit constructs a dependency parsing tree in ToDo list generation. The business support unit extracts a pair of a verb and an object from the tree to specify execution content of a task. The business support unit transmits a RESTful request to an external travel agency API in business trip arrangement. The business support unit includes a search condition in a JSON format in a payload of the request. The business support unit mathematically models and imitates a human cognitive process by these advanced algorithms. The business support unit eliminates a business bottleneck and maximizes processing throughput of the entire organization. The business support unit exhibits a tremendous effect in a use case such as automation of customer follow-up in a customer success department or efficiency improvement of back-office business in a general affairs department.

The creativity support unit automatically collects and analyzes, for example, success cases of different industries, application examples of the latest technology, past innovation cases, and the like using the generative AI, and generates optimal information and hints in accordance with a field of interest or a business theme of the user. For example, examples of different industries such as “examples of introducing a subscription model in the food industry”, “examples of utilizing AI in the construction industry”, and “remote diagnosis technology in the medical field” are automatically presented according to the industry and interest of the user. Furthermore, using an idea support phrase generation function by the generative AI, question examples prompting free ideas and phrases such as “what happens if this issue is considered from a perspective of a completely different industry?”, “let's think of a new combination without being bound by an existing framework”, and “let's remove all current constraints once and think freely” are automatically generated and presented to the user. Furthermore, specific hints and information for promoting creative thinking, such as “brainstorming support for new business ideas”, “extraction of differentiation points of existing services”, and “prediction of future market needs”, can also be automatically generated using the generative AI. Specific examples of a prompt sentence to be read by the generative AI include “Please analyze the following industry cases and propose applicability to other industries”, “Please generate 10 hints for devising a new business model in this field”, “Please list new ideas for differentiating existing services”, and the like. Specifically, the creativity support unit adopts a retrieval-augmented generation architecture combining a semantic search engine and a generative model. The creativity support unit inputs a query combining a profile vector of the user and a current task vector to the architecture. The creativity support unit extracts top K documents in cosine similarity from a vector database of millions of patents and papers using the query. The creativity support unit inputs texts of the extracted document group as a context to a large language model. The creativity support unit outputs an insight text specialized for a domain of the user from the large language model. The creativity support unit utilizes a reward model learned using a reinforcement learning from human feedback method in idea support phrase generation. The creativity support unit inputs candidates of generated phrases to the reward model and causes it to output a creativity score. The creativity support unit selects a phrase having a maximum creativity score and presents it to the user. The creativity support unit applies a tree of thoughts prompting method in brainstorming support. The creativity support unit generates a plurality of branched ideas from one initial idea by this method and searches for an optimal tree of ideas while evaluating each path. The creativity support unit outputs nodes and edges of this search process as a data structure of a visual mind map. The creativity support unit uses an autoregressive time-series prediction model in future market needs prediction. The creativity support unit inputs a volume transition tensor of past search queries to the model. The creativity support unit outputs an appearance probability of a keyword at a specific point in time in the future from the model. The creativity support unit establishes a systematic idea creation process that does not depend on human intuition or experience by these complex calculation processes. The creativity support unit reduces uncertainty of innovation and mathematically improves a success probability of a new business. The creativity support unit provides breakthrough value in a use case such as creative production in an advertising agency or concept design of a next-generation product in a manufacturing industry.

The user interface unit operates on the terminal and provides a dashboard, a notification function, a feedback input function, a report sharing function, and the like that allow the user to intuitively operate instructions for information collection, browsing of an analysis result and a report, selection of a decision-making plan, confirmation and approval of a business efficiency improvement task, reception and evaluation of a creativity support hint, and the like. For example, it can be configured such that a latest market trend summary, a recommended decision-making plan, an ongoing business efficiency improvement task, and a hint for creativity improvement can be confirmed at a glance on a dashboard screen. Specifically, the user interface unit adopts a single-page application architecture and realizes high-speed screen rendering using a virtual DOM. The user interface unit asynchronously receives a data stream in a JSON format transmitted from the server side. The user interface unit stores the received data in a store of a state management library. The user interface unit detects a state change of the store and re-renders only a related UI component. The user interface unit minimizes network traffic and memory consumption of a browser by this mechanism. The user interface unit utilizes a data visualization library such as D3.js or Chart.js on the dashboard screen. The user interface unit inputs multidimensional array data output from the information analysis unit to the library. The user interface unit outputs an interactive graph or chart in an SVG format from the library. The user interface unit uses a Server-Sent Events protocol in the notification function. The user interface unit receives a push notification from the server with low latency and displays it as a pop-up on the screen by this protocol. The user interface unit collects micro-interaction data such as click coordinates and a scroll amount of the user in the feedback input function. The user interface unit transmits the data to the server as a time-series event log. The user interface unit reduces a cognitive load of the user to the utmost limit by these technical configurations. The user interface unit improves responsiveness of the system and provides a seamless user experience. The user interface unit realizes an intuitive and efficient operation environment in a use case such as construction of a management dashboard or an integrated monitoring console for an operator.

The database management unit operates on the server, centrally stores and manages all data such as external and internal information acquired by the information collection unit, a summary and an analysis result generated by the analysis unit, a task, meeting minutes, and a schedule plan generated by the business support unit, and a hint and an idea generated by the creativity support unit, and realizes deduplication of information, version management, access authority management, backup, search optimization, and the like. Specifically, the database management unit adopts a polyglot persistence architecture integrating a relational database storing structured data, a NoSQL database storing unstructured data, and a vector database storing high-dimensional vector data. The database management unit saves the text data acquired by the information collection unit in a document-oriented database in a JSON format. The database management unit indexes a dense vector generated by inputting the text data to an embedding model into the vector database. The database management unit applies an HNSW algorithm to the vector index. The database management unit executes an approximate nearest neighbor search for tens of millions of records in milliseconds by this algorithm. The database management unit utilizes a Bloom filter data structure in deduplication of information. The database management unit probabilistically and rapidly determines whether a hash value of new data is included in an existing data set by this data structure. The database management unit implements an event sourcing pattern in version management. The database management unit saves a change history of data as an immutable event log in an append-only manner by this pattern. The database management unit accurately restores a data state at an arbitrary point in time by replaying the event log. The database management unit applies a hybrid model combining role-based access control and attribute-based access control in access authority management. The database management unit evaluates a dynamic access control policy according to a job title and an affiliated department of the user and a confidentiality level of data by this model. The database management unit mathematically guarantees integrity and availability of data by these advanced data management technologies. The database management unit streamlines a learning data pipeline of a large language model and dramatically improves performance of the entire system. The database management unit provides a robust data foundation in a use case such as integrated management of electronic medical records in a medical institution or auditing of transaction logs in a financial institution.

The security management unit implements user authentication, access control, communication encryption, data anonymization and masking, operation log recording, unauthorized access detection, information leakage prevention measures, and the like in order to ensure information security of the entire system, and applies a strict security policy particularly when handling internal confidential information or personal information. Specifically, the security management unit constructs a multi-layered defense system based on principles of a zero trust network architecture. The security management unit implements passwordless authentication by a FIDO2 protocol using a public key cryptography method in user authentication. The security management unit generates a signature using a hash value generated from biometric information of the user and a secret key unique to a device in this authentication process. The security management unit mathematically prevents spoofing by verifying the signature with a public key on the server side. The security management unit adopts a TLS 1.3 protocol in communication encryption and ensures perfect forward secrecy. The security management unit applies algorithms of k-anonymity and l-diversity in data anonymization. The security management unit inputs a data set including personal information to the algorithms and outputs an anonymized data set in which a quasi-identifier is generalized or suppressed. The security management unit makes identification of an individual statistically impossible by this processing. The security management unit uses an anomaly detection autoencoder using unsupervised learning in unauthorized access detection. The security management unit inputs a sequence of normal operation logs to the autoencoder to cause it to learn. The security management unit inputs a real-time operation log to the autoencoder and calculates a reconstruction error. The security management unit automatically blocks the session when the reconstruction error exceeds a dynamically set threshold value. The security management unit incorporates a data loss prevention module as an information leakage prevention measure. The security management unit applies regular expression matching and a machine learning-based confidential information classifier to text data transmitted by this module. The security management unit reduces a data breach risk due to a cyberattack or internal fraud to the utmost limit by these advanced cryptographic technologies and machine learning algorithms. The security management unit ensures reliability of the system and completely satisfies compliance requirements. The security management unit provides a highest-level security environment in a use case such as confidential document management in a government agency or cross-border data transfer in a global company.

In this way, the system according to the present embodiment functions as an advanced business support platform in which the information collection unit, the information analysis unit, the business support unit, the creativity support unit, the user interface unit, the database management unit, and the security management unit operate in cooperation with each other, and which comprehensively and automatically realizes business efficiency improvement, decision-making support, and creativity improvement of the user with the generative AI at the core. Specifically, the system couples components with each other by high-speed binary communication using a gRPC protocol. The system defines a strictly typed data schema using Protocol Buffers on this communication foundation. The system seamlessly passes a multidimensional tensor and structured JSON data between the units in accordance with this schema. The system applies a model quantization technology and a pruning technology in an inference pipeline of the generative AI. The system converts precision of a weight parameter of a neural network from a 32-bit floating point to an 8-bit integer by this technology. The system reduces memory usage and accelerates a processing speed by four times or more while maintaining inference accuracy by this conversion. The system orchestrates a series of processes from information collection to analysis and generation of a decision-making plan as an asynchronous directed acyclic graph triggered by an input query from the user. The system dynamically allocates an optimal computational resource at each node of the graph. The system achieves automation of intelligent processing at a level unreachable by a conventional rule-based system by integrating this advanced resource management and optimized algorithms. The system instantaneously derives an optimal solution from a vast data space exceeding human cognitive limits. The system fundamentally transforms knowledge management of an organization, not limited to mere business efficiency improvement. The system functions as a next-generation intelligent infrastructure in a use case such as integrated analysis of city data in a smart city or autonomous optimization of a supply chain in a large-scale manufacturing industry.

### (Implementation Steps)

Step 1: User Input and Theme Setting The user inputs a keyword or a business theme for which information collection or analysis is desired through the user interface unit of the terminal. For example, a plurality of specific themes and matters of interest such as “latest trends in generative AI”, “sustainability in the automobile industry”, “examples of launching new businesses”, and “M&A trends of competitors” can be specified simultaneously. The user can also set detailed conditions such as priority of information, a collection target period, a target region, and a target industry. Specifically, the system captures a natural language text input in the user interface unit in real time. The system transmits this text stream to a natural language understanding module on the server side. The system executes intent classification and slot filling of the input text using a pre-trained language model in this module. The system extracts an entity vector serving as a core of a search query from the input text by this processing. The system performs query expansion on the entity vector with reference to a synonym dictionary and an ontology graph. The system generates the expanded query vector. The system combines the detailed conditions such as the priority and the target period set by the user as a metadata filter into a query object in a JSON format. The system routes the query object to the subsequent information collection unit. The system converts an ambiguous instruction of the user into a strict mathematical expression processable by a computer in this input phase. The system significantly improves recall and precision of a search by this conversion. The system determines an initial condition of highly accurate information search while reducing an input load of the user. The system completely prevents noise contamination in an initial stage of a search in a use case such as a prior art search in a patent investigation or narrowing down of a target audience in marketing.

Step 2: Information collection processing The information collection unit accesses external information sources such as an external web search engine API, a news distribution service API, a paper database API, a patent database API, and an SNS public information API, as well as internal information sources such as an internal database API, an email server API, a file server API, a scheduler API, an internal chat API, and an internal project management system API, based on a keyword or a theme received from a user, and automatically and cross-sectionally collects related information. For example, the information collection unit collects a variety of information concurrently, such as articles and white papers related to “latest trends in generative AI”, academic papers related to “sustainability in the automobile industry”, internal reports related to “examples of launching new businesses”, and internal emails and attached files related to “M&A trends of competitors”, and centrally stores the collected information in a database on a server. Specifically, the information collection unit receives a query object generated in Step 1. The information collection unit transpiles this query object into a unique query character string conforming to a specification of each API. The information collection unit simultaneously issues HTTP requests to tens to hundreds of API endpoints using an asynchronous IO framework. The information collection unit implements rate limit control using a token bucket algorithm in this parallel processing. The information collection unit maximizes throughput while avoiding usage restrictions of each API by this control. The information collection unit temporarily stores response data returned from each API in a buffer on a memory. The information collection unit applies preprocessing such as character code normalization and HTML tag stripping to the data in this buffer. The information collection unit divides this preprocessed text data into chunks. The information collection unit inputs this chunk into an embedding model to generate a high-dimensional dense vector. The information collection unit combines this dense vector with original text data and metadata including an acquisition source URL and a time stamp. The information collection unit bulk-inserts this combined data record into a vector database and a document database. The information collection unit executes this series of processing in parallel by a plurality of worker nodes via a distributed message queue. The information collection unit completes petabyte-class data collection within a realistic time by this architecture. The information collection unit conceals network latency and dramatically improves data throughput of the entire system. The information collection unit provides an overwhelming advantage in use cases such as news sentiment collection for algorithmic trading in a financial market and threat intelligence collection in cybersecurity.

Step 3: Information organization and metadata addition For the collected information, the information collection unit automatically performs deduplication, classification by information source, and addition of metadata such as an acquisition date and time, a related keyword, and information reliability. For example, by eliminating duplication of articles and emails having the same content, performing tagging for each information source, and scoring freshness and reliability of information, efficiency and accuracy of subsequent analysis processing are improved. Specifically, the information collection unit applies mini-batch processing to a new data group stored in the database. The information collection unit calculates a TF-IDF vector for each text data in this batch. The information collection unit calculates a cosine similarity matrix for this vector group. The information collection unit detects a document pair in which an element of this matrix exceeds a preset threshold. The information collection unit sets a logical deletion flag for one of this pair having an older time stamp or a lower reliability score of the information source as duplicate data. The information collection unit mathematically eliminates redundancy of a data set by this deduplication processing. The information collection unit uses a pre-trained multi-class classification neural network in classification by information source. The information collection unit inputs a text tensor to this network and causes the network to output a probability distribution of categories. The information collection unit adds a category label corresponding to a maximum value of this probability distribution as metadata. The information collection unit applies a gradient boosting decision tree model using domain authority of the information source and a past fact-check history as feature amounts in calculating the reliability score of the information. The information collection unit outputs a reliability score, which is a continuous value in a range of 0 to 100, from this model. The information collection unit adds this score to an index of the database as metadata. The information collection unit fundamentally reduces a risk of a subsequent generative AI model causing hallucination by these advanced data cleansing and enrichment processes. The information collection unit eliminates waste of calculation resources and dramatically improves a processing speed and output accuracy of an analysis phase. The information collection unit establishes an extremely high-quality data infrastructure in use cases such as evidence-based paper search in a medical field and construction of a precedent database in a legal department.

Step 4: Summarization and keyword extraction by generative AI The information analysis unit executes natural language processing using a generative AI on a large amount of collected and organized information, and performs summarization, important point extraction, keyword extraction, and trend analysis of each document. For example, the information analysis unit generates a summary of several lines from a market research report spanning 10 pages, and extracts frequent keywords and topics from a plurality of news articles. Specific examples of a prompt sentence to be read by the generative AI include “Please summarize the following plurality of market research reports and extract major trends and risk factors”, “Please summarize the content of these meeting minutes in three lines and list action items for the next time”, and “Please extract important tasks from the following email text and arrange them in order of priority”. Specifically, the information analysis unit adopts a multi-layer neural network architecture equipped with a self-attention mechanism. The information analysis unit tokenizes input text data. The information analysis unit converts each token into a high-dimensional word embedding vector. Input data to the neural network is, for example, a sequence of word embedding vectors consisting of 512-dimensional floating-point numbers. Specific examples of the input data include word vectors such as “market”, “growth”, and “risk” extracted from the text of the market research report. The neural network executes a matrix operation on these input vectors. The neural network calculates a context dependency relationship. Output data from the neural network is an appearance probability distribution of each token constituting a summary sentence. A specific example of the output data includes an array of probability values of each word constituting a phrase “demand expands”. The information analysis unit sequentially selects a token having the highest probability. The information analysis unit concatenates the selected tokens to generate a summary text. The information analysis unit transmits the generated summary text to the subsequent business support unit. The business support unit uses the received summary text as basic data for decision-making. This processing method is fundamentally different from a conventional mental process in which a human manually reads a document. The system extracts a feature of text through a vector operation in a high-dimensional space. Thereby, the system dramatically improves an information processing speed. The system generates an objective summary eliminating human cognitive bias. This technology is applicable to operations of a research and development department and a corporate planning department that require a vast amount of literature research. The system can also adopt a configuration in which a plurality of language models are ensemble-learned. The system optimizes a weight of a model using a cross-entropy error function. The system updates a parameter by a gradient descent method.

Step 5: Risk evaluation and trend analysis by generative AI The information analysis unit extracts a risk factor and a trend change from the collected information using the generative AI, and generates an analysis result in a visual format such as a time-series graph, a heat map, and a word cloud. For example, the information analysis unit extracts a risk factor from past failure cases related to “launching a new business”, and calculates a risk score such as “non-compliance with laws and regulations at the time of market entry is a main risk” and “lack of grasping trends of competitors is a failure factor”. Specific examples of a prompt sentence to be read by the generative AI include “Please extract a risk factor from the following case data and calculate a risk score” and “Please analyze a trend change in this field in chronological order and summarize major change points”. Specifically, the information analysis unit includes a multimodal neural network that integrally processes time-series data and text data. Input data to the neural network is a multidimensional tensor obtained by vectorizing a past case text, and time-series array data indicating an occurrence date and time. Specific examples of the input data include an embedding vector of a text describing a past business failure case, and a one-dimensional numerical array indicating an occurrence frequency of a specific event. The information analysis unit applies a convolution operation to the input data. The information analysis unit extracts a local feature amount. The information analysis unit learns a time-series dependency relationship using a recurrent neural network layer. Output data from the neural network is an array of risk scores represented by floating-point numbers from 0.0 to 1.0 for each risk factor. Specific examples of the output data include a score of 0.85 for a non-compliance risk with laws and regulations, and a score of 0.62 for a competitor entry risk. The information analysis unit inputs the calculated risk score to a threshold determination module. The threshold determination module generates a warning flag when the score exceeds a predetermined threshold. The system highlights a specific area of the heat map based on the warning flag. This processing method utilizes a non-linear transformation in a high-dimensional feature space. The system mathematically detects a minute trend change that a human cannot intuitively grasp. Thereby, the system significantly improves accuracy of risk evaluation. The system realizes efficiency improvement of data management. This technology is applicable to credit examination of a financial institution and supply chain risk management of a manufacturing industry. The system can also adopt a configuration in which learning data is expanded using a generative adversarial network. The system trains a model so as to minimize a mean square error.

Step 6: Automatic generation of decision-making support plan The business support unit automatically generates a plurality of options for decision-making related to a business of a user using the generative AI based on an output result of the information analysis unit, automatically calculates a risk score and advantages and disadvantages referring to past cases and statistical data for each of the options, and presents an optimal option as a recommended plan. For example, the business support unit generates options such as “utilization of existing technology”, “cooperation with external partners”, and “introduction of new technology” as a “progress method of a new project”, and automatically generates an evaluation such as “introduction cost is low but market differentiation is difficult” and “superiority in a market is high but development risk is high” for each of the options. Specific examples of a prompt sentence to be read by the generative AI include “Please generate three decision-making plans based on the following analysis result, and calculate advantages and disadvantages and a risk score of each”. Specifically, the business support unit executes a large language model incorporating a reinforcement learning algorithm. Input data to this model is a risk score array output from the information analysis unit and an embedding vector of a summary text. Specific examples of the input data include a numerical vector indicating a market growth rate and a text feature amount tensor indicating a trend of a competitor. The business support unit applies a non-linear transformation using a multi-layer perceptron to the input data. Output data from this model is text data indicating a plurality of decision-making options and a numerical array of expected reward values corresponding to each option. Specific examples of the output data include a text “utilization of existing technology” and an expected reward value 0.75 for it, and a text “introduction of new technology” and an expected reward value 0.60. The business support unit inputs the output expected reward value to a sort algorithm. The business support unit transmits an option having the highest value as a recommended plan to a user interface unit. This processing method eliminates a conventional decision-making process depending on a human rule of thumb. The system introduces an objective evaluation criterion based on a probabilistic approach. Thereby, the system reduces an error in decision-making. The system searches for an optimal solution while suppressing consumption of calculation resources. This technology is applicable to strategy planning of a management layer and resource allocation business of a project manager. The system can also adopt a state transition model based on a Markov decision process. The system optimizes a parameter of a model using a policy gradient method. The system includes a mechanism for dynamically adjusting a reward function.

Step 7: Automatic execution of business efficiency improvement task The business support unit automates routine work such as schedule adjustment, email reply, meeting minutes creation, ToDo list generation, and business trip arrangement using the generative AI. For example, the business support unit automatically collates schedules of related parties and proposes an optimal meeting date and time, analyzes content of a received email and generates an automatic email reply template, transcribes meeting audio data and extracts main points, extracts a task from an email or a schedule, assigns a priority and a deadline, and lists the task, and automatically searches for and reserves a transportation means and an accommodation based on a destination and a schedule. Specific examples of a prompt sentence to be read by the generative AI include “Please transcribe the following meeting audio data and summarize main points for each speaker”, “Please generate an appropriate reply sentence to the content of this email”, and “Please create a ToDo list from the following schedule and email content”. Specifically, the business support unit executes pipeline processing in which a voice recognition model and a natural language understanding model are connected. Input data to this pipeline is a voice waveform tensor converted from recording data of a meeting and a text array of a received email. Specific examples of the input data include one-dimensional voice waveform data digitized at a sampling rate of 16 kilohertz and a token array obtained by dividing an email text in units of characters. The business support unit applies a fast Fourier transform to the voice waveform tensor. The business support unit extracts an acoustic feature amount. The business support unit inputs the extracted feature amount to the natural language understanding model. Output data from this model is hierarchical structured data consisting of a pair of a key and a value. A specific example of the output data includes structured data in which a character string and date data are assigned to each item of a task name, a person in charge, and a deadline. The business support unit writes the output structured data into a task management database. The business support unit transmits a registration request to an external scheduler system via an application programming interface. This processing method completely replaces a conventional operation in which a human manually inputs data. The system completes processing by direct data communication between computers. Thereby, the system eliminates a delay in data input. The system mathematically brings an occurrence rate of an input mistake close to zero. This technology is applicable to customer response business of a sales department and clerical processing of a general affairs department. The system can also use a voice recognition engine using a hidden Markov model as an alternative. The system learns a voice recognition model using a connectionist temporal classification loss function.

Step 8: Creativity support and idea generation promotion The creativity support unit automatically collects and analyzes successful examples of different industries, application examples of the latest technology, past innovation cases, and the like using the generative AI, and generates optimal information and hints in accordance with a field of interest and a business theme of a user. Furthermore, the creativity support unit automatically generates idea support phrases and question examples prompting free ideas, and presents them to the user. For example, the creativity support unit presents “examples of introducing a subscription model in the food industry”, “examples of utilizing AI in the construction industry”, “remote diagnosis technology in the medical field”, and the like, and generates idea support phrases such as “what happens if this problem is considered from a perspective of a completely different industry?” and “let's think about a new combination without being bound by an existing framework”. Specific examples of a prompt sentence to be read by the generative AI include “Please analyze the following industry cases and propose applicability to other industries”, “Please generate 10 hints for devising a new business model in this field”, and “Please list new ideas for differentiating an existing service”. Specifically, the creativity support unit includes a generative model that executes a vector operation in a latent space. Input data to this generative model is a high-dimensional query vector obtained by converting a keyword group indicating a field of interest of a user, and a context vector extracted from a case database of different industries. Specific examples of the input data include a 768-dimensional vector indicating a feature of the food industry and a feature amount tensor indicating a structure of a subscription model. The creativity support unit calculates a cosine similarity between these input vectors. The creativity support unit combines vectors having a similarity within a predetermined range. Output data from this generative model is a text sequence describing a new idea and an evaluation score indicating novelty of the idea. Specific examples of the output data include text data “a service combining regular delivery of food and remote health diagnosis” and a floating-point number of a novelty score 0.92. The creativity support unit inputs the output text sequence to a natural language generation module. The natural language generation module constructs an idea support phrase for the user. This processing method is different from conventional brainstorming depending on human associative memory. The system searches for an intersection of concepts based on a mathematical distance calculation in a high-dimensional vector space. Thereby, the system generates a combination of a wide range of knowledge exceeding a human cognitive limit at high speed. The system dramatically improves efficiency of idea creation. This technology is applicable to planning business of a new business development department and a product design department. The system can also construct a latent space using a variational autoencoder. The system normalizes a distribution of a latent variable using a Kullback-Leibler divergence.

Step 9: Automatic report generation and user presentation Each unit operates in cooperation with each other, automatically generates a report integrating an information collection result, an analysis result, decision-making support content, business efficiency improvement progress, and creativity improvement support content on a server side, and presents the report to a user through a user interface unit on a terminal side. The user can check a latest market trend summary, a recommended decision-making plan, an ongoing business efficiency improvement task, a hint for creativity improvement, and the like at a glance on a dashboard screen. Furthermore, input of a comment and feedback on report content, sharing with related parties, automatic generation of a new task and a meeting based on the report content, and the like are also possible. Specifically, the server executes a rendering engine that integrates heterogeneous data output from each processing unit. Input data to this rendering engine is a multimodal data set including a text array, a numerical matrix, and an image tensor. Specific examples of the input data include character string data of a summary text generated by the information analysis unit and a floating-point number array of a risk score calculated by the business support unit. The server maps the input data to a predetermined display template. The server dynamically generates a structured document described in a hypertext markup language. Output data from the server is a data stream including an instruction set for drawing. Specific examples of the output data include an array of coordinate data for drawing a graph and style designation data for arranging text. The server transmits the output data to the terminal via a network interface. The user interface unit of the terminal analyzes the received data stream. The terminal draws a graphical dashboard on a display. This processing method eliminates a conventional method in which a human switches a plurality of applications to aggregate information. The system integrates information in real time through a single data pipeline. Thereby, the system optimizes consumption of a communication band. The system minimizes a delay in screen drawing. This technology is applicable to construction of a management dashboard and a display system of an integrated monitoring center. The system can also adopt a configuration in which only a differential update of a screen is performed using a virtual document object model. The system includes a machine learning model that acquires line-of-sight movement data of a user and dynamically optimizes a display layout.

### (Specific Use Case)

For example, a case is assumed in which a manager supervising a plurality of business departments needs to comprehensively grasp domestic and overseas market trends, movements of competitors, related technology trends, internal past cases, latest information on laws and regulations, and the like in a short period of time and make an optimal decision when launching a new business. In this case, a user inputs a plurality of keywords and themes such as “new business launch”, “generative AI”, “overseas market”, “laws and regulations”, and “competitor trend” through a user interface unit of a terminal, and specifies conditions such as a target period, a target region, and a priority of information collection. The information collection unit automatically collects, for example, latest articles, white papers, academic papers, patent information, SNS posts of experts, and the like related to “overseas expansion of new business utilizing generative AI” using an external web search engine API, a news distribution service API, a paper database API, a patent database API, an SNS public information API, and the like. Furthermore, the information collection unit simultaneously collects, for example, reports of past new business launch projects, minutes of related internal meetings, email and chat histories with internal and external related parties, past schedules and task information, and the like using an internal database API, an email server API, a file server API, a scheduler API, an internal chat API, an internal project management system API, and the like. The information collection unit centrally stores these pieces of information in a database on a server, and automatically performs deduplication and metadata addition. Specifically, the information collection unit includes a distributed web crawler and an asynchronous communication module. Input data to the information collection unit is structured query data including a search condition transmitted from the user interface unit. Specific examples of the input data include a character string array of a search keyword and range data of a time stamp indicating a target period. The information collection unit generates request packets for a plurality of external application programming interfaces in parallel based on the input data. The information collection unit sends out the generated packets to a network. Output data received by the information collection unit is hypertext data and structured text data returned from an external server. Specific examples of the output data include character string data including a text of a news article and hierarchical data including bibliographic information of a patent. The information collection unit inputs the received output data to a natural language processing pipeline. This pipeline extracts a named entity from text. The information collection unit adds the extracted named entity to original data as metadata. The information collection unit calculates a hash value of data. The information collection unit physically deletes duplicate data by comparing hash values. This processing method completely automates a conventional process in which a human manually operates a search engine. The system conceals a network waiting time by multi-thread processing. Thereby, the system exponentially improves a data collection speed. The system minimizes consumption of a storage capacity. This technology is applicable to market research business and competitor analysis business. The system can also include a mechanism for avoiding an access restriction using a pool of proxy servers. The system reduces a calculation amount of duplication determination using a Bloom filter.

The information analysis unit executes natural language processing using a generative AI on a large amount of collected information, extracts important points, conclusions, frequent keywords, trend change points, risk factors, and the like from, for example, a market research report of 10 pages or more, a plurality of news articles, a long internal report, and the like, and automatically generates an analysis result in a format such as a summary sentence, a keyword list, a time-series graph, a heat map, and a word cloud. For example, it extracts summaries such as “demand for services utilizing generative AI will rapidly increase in overseas markets from 2024 onwards”, “competitors are already developing new businesses utilizing generative AI”, and “strengthening of laws and regulations is a future risk factor”, and keywords such as “generative AI”, “market expansion”, “regulatory strengthening”, and “competitor entry”. Specific examples of prompt sentences to be read by the generative AI include “Please summarize the following plurality of market research reports and extract major trends and risk factors”, “Please summarize the content of these meeting minutes in three lines and list action items for the next time”, and “Please extract important tasks from the following email text and arrange them in order of priority”. Specifically, the information analysis unit deploys a large language model based on a transformer architecture on a memory. Input data to the model is an array of token identifiers obtained by dividing text data transferred from the information collection unit in units of subwords. Specific examples of the input data include a one-dimensional integer array obtained by digitizing each sentence of a market research report, and a token sequence indicating a title of a news article. The information analysis unit adds positional encoding to the input data. The information analysis unit calculates a degree of relevance between tokens using a multi-head attention mechanism. Output data from the model is a character string array of extracted keywords and numerical data indicating an importance of each keyword. Specific examples of the output data include a pair of a character string “generative AI” and an importance score of 0.95, and a pair of a character string “regulatory strengthening” and an importance score of 0.88. The information analysis unit inputs the output keyword array to a clustering algorithm. The algorithm groups similar keywords to generate drawing data for a word cloud. This processing method eliminates conventional mental work in which a human reads a document and summarizes main points. The system analyzes a semantic structure of text by a product-sum operation of matrices in a high-dimensional space. Thereby, the system improves accuracy of information extraction. The system significantly reduces calculation time required for processing. This technology is applicable to contract review in a legal department and media analysis in a public relations department. The system can also adopt a configuration of performing fine-tuning on a pre-trained model using data of a specific business domain. The system suppresses overfitting using a dropout layer.

Based on an output result of the information analysis unit, the business support unit automatically generates a plurality of options such as “utilization of existing technology”, “cooperation with external partners”, and “introduction of new technology” as, for example, a “progress method of launching a new business” using the generative AI, automatically calculates a risk score and advantages and disadvantages referring to past cases and statistical data for each of the options, and presents an optimal option as a recommended plan. For example, it automatically generates evaluations such as “utilization of existing technology” is “low introduction cost but difficult market differentiation”, and “introduction of new technology” is “high market superiority but high development risk”. Furthermore, in schedule adjustment, it automatically collates schedules of related parties and proposes an optimal meeting date and time; in email reply, it analyzes content of a received email and generates an automatic reply template; in meeting minutes creation, it transcribes audio data of a web meeting and extracts main points; in ToDo list generation, it extracts tasks from emails and schedules, assigns priorities and deadlines, and lists them; and in business trip arrangement, it automatically searches for and reserves transportation means and accommodations based on a destination and a schedule. Specific examples of prompt sentences to be read by the generative AI include “Please generate three decision-making plans based on the following analysis results, and calculate advantages and disadvantages and a risk score for each”, “Please transcribe the following meeting audio data and summarize main points for each speaker”, “Please generate an appropriate reply text to the content of this email”, and “Please create a ToDo list from the following schedule and email content”. Specifically, the business support unit executes a conditional generative model and an optimization solver in cooperation with each other. Input data to the generative model is a tensor of the keyword array and the importance score output from the information analysis unit. Specific examples of the input data include a feature vector indicating market trends and a numerical matrix indicating past project success rates. The business support unit maps the input data to a latent space. The business support unit generates a plurality of option texts using a decoder network. Output data from the generative model is text data of the options and multidimensional evaluation index vectors corresponding respectively thereto. Specific examples of the output data include a text “cooperation with external partners” and a vector including a cost index of 0.4 and a risk index of 0.6. The business support unit inputs the output evaluation index vectors to the optimization solver. The solver calculates a Pareto optimal solution. The solver assigns a recommendation flag to the most balanced option. This processing method replaces a conventional planning process relying on human intuition with a mathematical optimization problem. The system searches for an optimal combination from a vast parameter space at high speed. Thereby, the system ensures objectivity of decision-making. The system maximizes execution efficiency of business processes. This technology is applicable to route optimization of a supply chain and personnel allocation planning in a human resources department. The system can also adopt a configuration of simulating crossover and mutation of options using a genetic algorithm. The system evaluates a solution of each generation using a fitness function.

The creativity support unit automatically collects and analyzes, for example, successful examples of different industries, application examples of the latest technology, past innovation examples, and the like using the generative AI, and generates optimal information and hints in accordance with a field of interest and a business theme of the user. For example, it automatically presents examples of different industries according to the industry and interest of the user, such as “examples of introducing a subscription model in the food industry”, “examples of utilizing AI in the construction industry”, and “remote diagnosis technology in the medical field”, and further automatically generates idea support phrases and question examples prompting free ideas, and presents them to the user. For example, it generates idea support phrases such as “what happens if this problem is considered from the perspective of a completely different industry?”, “let's think of a new combination without being bound by existing frameworks”, and “let's remove all current constraints once and think freely”. Specific examples of prompt sentences to be read by the generative AI include “Please analyze the following industry examples and propose applicability to other industries”, “Please generate 10 hints for devising a new business model in this field”, and “Please list new ideas for differentiating existing services”. Specifically, the creativity support unit executes a processing pipeline integrating a cross-domain recommendation algorithm and a natural language generation model. Input data to the pipeline is a feature vector indicating a current business domain of the user and a group of example vectors extracted from a different industry database. Specific examples of the input data include a 512-dimensional numerical vector indicating characteristics of the construction industry and a feature tensor indicating remote diagnosis technology in the medical field. The creativity support unit executes an inner product calculation on the input vector group. The creativity support unit measures a semantic distance between domains. Output data from the pipeline is text data of an example whose distance exceeds a certain threshold but which has a high correlation in a specific latent dimension, and a prompt character string for prompting an idea. Specific examples of the output data include text data “apply remote diagnosis technology in medical care to safety confirmation at a construction site” and a question character string “what happens if current constraints are removed?”. The creativity support unit transmits the output text data to a display queue of a user interface unit. The user interface unit pop-up displays the received data in a designated area on a screen. This processing method breaks through a conventional process in which a human thinks within the framework of existing knowledge. The system intentionally generates discontinuous information combinations using orthogonality of a vector space. Thereby, the system mathematically increases a creation probability of highly novel ideas. The system improves diversity of information retrieval. This technology is applicable to creative production in an advertising agency and new theme search in a research institute. The system can also adopt a configuration of modeling complex relationships between examples using a graph neural network. The system optimizes edge weights between nodes by learning.

Finally, the respective units operate in cooperation with each other, automatically generate a report integrating an information collection result, an analysis result, decision-making support content, business efficiency improvement progress, and creativity improvement support content on the server side, and present the report to the user through the user interface unit on the terminal side. The user can check at a glance the latest market trend summary, recommended decision-making plans, ongoing business efficiency improvement tasks, hints for creativity improvement, and the like on a dashboard screen, and can further input comments and feedback on the report content, share it with related parties, and automatically generate new tasks and meetings based on the report content. Specifically, the server executes an integrated controller that aggregates output data from each processing unit via an asynchronous messaging queue. Input data to the controller is a stream of structured data objects asynchronously transmitted from each unit. Specific examples of the input data include a data object including summary text from the information analysis unit and integer value data indicating a task progress rate from the business support unit. The controller merges the input data into a shared data structure on a memory. The controller verifies data consistency. Output data from the controller is payload data for real-time update compliant with a WebSocket protocol. Specific examples of the output data include a command character string for updating a specific widget on a screen and coordinate array data for redrawing a graph. The server push-distributes the output data to the terminal. The terminal dynamically rewrites a document object model of the screen based on the received payload data. This processing method eliminates a conventional polling method in which a user manually updates a screen. The system reduces communication overhead between the server and the terminal by an event-driven architecture. Thereby, the system improves response speed of the entire system. The system optimizes utilization efficiency of a network bandwidth. This technology is applicable to a real-time monitoring system for financial transactions and a production line monitoring dashboard in a factory. The system can also adopt a configuration of executing a part of data integration processing on the terminal side using an edge computing technology. The system dynamically controls communication priority according to importance of data.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying out the Present Invention)

Embodiments for carrying out the present invention will be described exhaustively, in detail, and with depth, with further increased specificity.

A smart city integrated operation support system of the present invention collects and analyzes all operation data of a city in real time, automatically and comprehensively supports decision-making, business efficiency improvement, resident service improvement, disaster response, environmental conservation, and sustainable development of the city by a city manager and an administrative official, and is configured to include a city data collection unit, a city data analysis unit, a city operation support unit, a creative city policy generation unit, a user interface unit, a database management unit, and a security management unit. Specifically, the system adopts a distributed processing architecture in which a cloud computing environment and an edge device are linked. The system constantly communicates with tens of thousands of sensor nodes arranged in the city. Input data to the system is multidimensional time-series telemetry data transmitted from each sensor node. Specific examples of the input data include integer data indicating a count value of vehicles acquired from a camera at an intersection, and floating-point number data of temperature and humidity acquired from a weather sensor. The system primarily processes the input data by an edge server. The system executes noise removal and data compression. Output data from the system is a normalized data stream transmitted to a cloud server. Specific examples of the output data include an average value array of traffic volume aggregated at one-minute intervals, and an environmental data packet to which an anomaly value flag is added. The system writes the output data to an in-memory database of the database management unit. This processing method is different from a conventional centralized system in which processing is performed by all central servers. The system prevents network congestion by distributing a calculation load on the edge side. Thereby, the system ensures real-time performance of data processing. The system improves fault tolerance of the entire system. This technology is applicable to monitoring of a wide-area infrastructure and management of a large-scale logistics network. The system can also adopt a microservice architecture to deploy each processing unit as an independent container. The system includes an auto-scaling function of automatically increasing or decreasing the number of containers according to a load situation.

The city data collection unit has a function of automatically and cross-sectionally collecting data from various information sources inside and outside the city. For example, as traffic data, it automatically acquires traffic volume sensors of main roads and intersections, operation statuses of traffic lights, operation status APIs of public transportation, delay information of buses and railways, operation data of shared bicycles and car sharing, availability of parking lots, taxi dispatch data, and the like. For example, it collects information in real time, such as on which roads traffic congestion is occurring during morning and evening rush hours, to what extent delays of buses and railways are occurring, in which areas utilization of shared bicycles is concentrated, in which regions full/empty information of parking lots is tight, and in which time zones and regions demand for taxis is increasing. As energy data, it acquires power consumption of the entire city, power generation amount of renewable energy, operation status of storage batteries, consumption peaks of respective facilities, usage amounts of gas and water, energy supply and demand balance, anomaly detection data of a power system, and the like from a power company and a city infrastructure API. For example, it grasps in real time a power consumption peak on a midsummer day, transition of a renewable energy ratio, charge/discharge status of storage batteries, rapid increase in gas consumption, water leakage detection, and the like. As environmental data, it acquires fine particle concentrations in the atmosphere (PM2.5, NOx, SOx, etc.), carbon dioxide concentration, temperature, humidity, noise level, river water level, rainfall amount, ultraviolet ray amount, soil pollution data, indicators of an urban heat island phenomenon, and the like from an IoT sensor and a weather API. Examples thereof include a warning when the concentration of PM2.5 or NOx exceeds a reference value, early detection of a flood risk due to a rapid rise in river water level, identification of an area with frequent noise complaints, and grasping of progress of the urban heat island phenomenon. As disaster prevention data, it automatically collects occurrence information of earthquakes and typhoons, tsunami warnings, operation statuses of evacuation shelters, damage reports during disasters, disaster-related posts on SNS, fire/ambulance dispatch histories, landslide disaster warning information, lifeline damage statuses, and the like. For example, it grasps in real time seismic intensity distribution upon occurrence of an earthquake, congestion status of evacuation shelters upon approach of a typhoon, rapid increase in damage reports on SNS, real-time grasping of fire dispatches, identification of landslide disaster warning areas, and the like. As administrative data, it acquires congestion status of counters, the number of applications for administrative procedures, the number of inquiries from residents, usage status of administrative services, tax revenue/budget execution status, operation rates of public facilities, participation status of administrative events, and the like from an administrative system API. For example, it collects congestion degree of a resident card issuance counter, increase/decrease in online applications, utilization rate of administrative services, usage reservation status of public facilities, the number of participants in administrative events, and the like. As resident feedback, it automatically collects delays in garbage collection, road cave-ins, noise complaints, defect reports of public facilities, resident satisfaction questionnaires, posts related to municipal administration on SNS, reports from resident applications, and the like. Examples thereof include complaints regarding garbage collection delays from residents, road cave-in reports, identification of areas with frequent noise complaints, equipment defect reports of public facilities, time-series changes in resident satisfaction, and opinion analysis on municipal administration on SNS. These data are centrally stored in a database on a server, and deduplication, metadata addition (acquisition date and time, information source, related keyword, etc.), data normalization, automatic detection of anomaly values, data quality evaluation, and the like are also automatically performed. Specifically, the city data collection unit includes a protocol conversion gateway that interprets a plurality of communication protocols and a stream processing engine. Input data to the gateway is raw sensor payload data transmitted in different standards. Specific examples of the input data include binary data of a temperature sensor transmitted by a Message Queuing Telemetry Transport protocol, and structured text data of public transportation acquired via a Hypertext Transfer Protocol. The gateway converts the input data into a common internal data format. The stream processing engine applies a Kalman filter to the converted data. The engine mathematically corrects a measurement error of the sensor. Output data from the city data collection unit is a multidimensional time-series vector to which a time stamp and spatial coordinates are added. Specific examples of the output data include an environmental data vector including latitude/longitude information and a PM2.5 concentration value, and a traffic data vector including an intersection identifier and a congestion length. The city data collection unit transfers the output data to an input buffer of the city data analysis unit. This processing method completely eliminates a conventional manual process in which a human individually downloads data from each system. The system integrates data of heterogeneous formats in real time. Thereby, the system reduces calculation time required for data preprocessing. The system ensures data quality in subsequent analysis processing. This technology is applicable to sensor data integration in a factory and a wide-area agricultural monitoring system. The system can also adopt a configuration of executing a machine learning model on the edge device side to filter abnormal data in advance. The system automatically complements a missing part of data by spline interpolation.

The city data analysis unit applies natural language processing using a generative AI, an anomaly detection algorithm, a machine learning model, time-series analysis, clustering, causal inference, and the like to a vast amount of data collected by the city data collection unit, and automatically executes summarization of various data, anomaly value detection, trend analysis, risk evaluation, resident needs extraction, future prediction, scenario analysis, and the like. For example, it detects anomalies such as “traffic congestion twice as much as usual occurs on a main arterial road”, “delays in public transportation tend to expand”, and “taxi demand rapidly increases in a specific area” from traffic data, and extracts trends and anomalies such as “power consumption records a record high”, “renewable energy ratio rises”, “gas consumption rapidly increases”, and “water leakage is detected” from energy data. From environmental data, it identifies risks and issues such as “fine particle concentration in the atmosphere exceeds a reference value”, “river water level reaches a warning level”, “noise complaints frequently occur in a specific area”, and “heat island phenomenon progresses”. From disaster prevention data, it extracts disaster risks and resident behaviors such as “damage reports rapidly increase after occurrence of an earthquake”, “congestion degree of evacuation shelters rises”, “disaster-related posts on SNS increase”, and “landslide disaster warning areas expand”. From administrative data, it extracts operation issues and improvement points such as “counter congestion concentrates on a specific day of the week and time zone”, “utilization rate of online applications rises”, “operation rate of public facilities decreases”, and “the number of participants in administrative events decreases”. From resident feedback, it extracts resident needs and issues such as “complaints regarding garbage collection delays increase”, “road cave-in reports frequently occur in a specific area”, “resident satisfaction tends to decrease”, and “administrative criticism on SNS increases”. Furthermore, the analysis result is automatically generated in a visual format such as text, a graph, a chart, a heat map, a word cloud, a time-series graph, a heat map on a map, a causal relationship diagram, and a future prediction graph that is intuitively easy for the user to understand, using a natural language generation function by the generative AI. For example, it automatically generates a time-series transition graph of traffic congestion, a peak prediction graph of energy consumption, a map heat map of environmental risks, a time-series change graph of resident satisfaction, a clustering result of administrative service utilization rates, and the like. Specifically, the city data analysis unit executes an anomaly detection model based on an autoencoder and a time-series prediction model using a long short-term memory network in parallel. Input data to the anomaly detection model is a multidimensional time-series vector transferred from the city data collection unit. Specific examples of the input data include a numerical array indicating transition of power consumption in the past 24 hours, and a time-series tensor of a noise level in a specific area. The city data analysis unit inputs the input data to an encoder layer of the autoencoder and compresses it into a low-dimensional latent representation. The city data analysis unit restores original data using a decoder layer. Output data from the model is a floating-point number indicating a reconstruction error between the input data and the restored data. Specific examples of the output data include a reconstruction error value of 0.85 exceeding an error range in a normal state, and an error value of 0.12 of a normal pattern. The city data analysis unit generates an anomaly detection flag when the reconstruction error exceeds a threshold. The city data analysis unit transmits the anomaly detection flag to the city operation support unit. This processing method replaces a conventional process in which a human visually checks a monitoring monitor. The system learns a non-linear correlation in a high-dimensional data space. Thereby, the system detects an unknown anomaly pattern with high accuracy. The system reduces an occurrence rate of false alarms. This technology is applicable to predictive maintenance of a plant and intrusion detection of cybersecurity. The system can also adopt a configuration of learning variations of normal data using a generative adversarial network. The system probabilistically identifies a root cause of an anomaly using a causal inference algorithm.

The city operation support unit has a function of automatically generating an optimal policy plan necessary for city operation using the generative AI based on an output result of the city data analysis unit, and further automatically executing routine work in cooperation with a signal control system, a notification distribution system, a public transportation schedule adjustment system, an energy supply and demand adjustment system, an administrative procedure system, a disaster information distribution system, and the like. For example, when traffic congestion occurs, it proposes “signal control optimization for a congested section”, “increase in public transportation flights”, “guidance notification of a detour”, “priority control of taxi dispatch”, and the like, and when energy consumption reaches a peak, it recommends “automatic distribution of a power saving request notification”, “utilization of storage batteries”, “consumption suppression of some facilities”, “priority utilization of renewable energy”, and the like. When an environmental risk is increasing, it proposes “operation enhancement of an air purification device”, “outing self-restraint notification to citizens”, “enhancement of river monitoring”, “identification of and countermeasure against a noise source”, and the like. When a disaster risk is high, it recommends “preparation for opening evacuation shelters”, “evacuation information notification to residents”, “damage status grasping by a drone”, “optimization of fire/ambulance dispatch”, and the like. When congestion of an administrative counter occurs, it proposes “expansion of online reservation slots”, “increase in counter staff”, “promotion of online procedures”, “congestion prediction notification to residents”, and the like. For example, when traffic congestion is detected, it sends an automatic command to the signal control system to optimize time allocation of green lights, issues a flight increase command to the public transportation schedule adjustment system, and automatically transmits a detour guidance notification to a smartphone application of a resident. When energy consumption reaches a peak, it automatically transmits a power saving request notification to a smartphone application of a resident, automatically controls charge/discharge of storage batteries, and instructs priority utilization of renewable energy. When a disaster risk increases, it automatically updates an opening status of evacuation shelters, simultaneously distributes evacuation information to residents, automatically instructs damage status grasping by a drone, and optimizes fire/ambulance dispatch. Specifically, the city operation support unit executes a control module implementing a reinforcement learning agent and a proportional-integral-derivative control algorithm. Input data to the control module is the anomaly detection flag and a future prediction tensor output from the city data analysis unit. Specific examples of the input data include a numerical vector indicating congestion prediction after 30 minutes at a specific intersection, and a probability value array indicating a supply and demand tightness degree of a power grid. The city operation support unit updates a state space based on the input data. The city operation support unit calculates an optimal action value function using the reinforcement learning agent. Output data from the control module is a control command packet for directly operating external infrastructure equipment. Specific examples of the output data include binary command data for extending a blue lighting time of a traffic light by 15 seconds, and a control signal for starting discharge of a storage battery. The city operation support unit transmits the output data to each actuator via a dedicated secure communication network. The actuator drives physical equipment in accordance with the received command. This processing method eliminates a conventional intervention process in which a human operates equipment according to a manual. The system constructs a feedback loop in units of milliseconds to autonomously control city infrastructure. Thereby, the system maximizes operation efficiency of infrastructure. The system reduces wasteful consumption of energy. This technology is applicable to power grid control of a smart grid and a traffic control system of an autonomous driving vehicle. The system can also adopt a configuration of optimizing a state a plurality of steps ahead using model predictive control. The system includes a fail-safe mechanism that verifies safety in a simulation environment before executing a control command.

The creative city policy generation unit has a function of automatically generating a new and unprecedented city policy plan, such as promotion of urban agriculture, garbage collection route optimization by AI, citizen-participatory energy sharing, IoT implementation in parks, drone utilization during a disaster, introduction of smart streetlights, introduction of automatic cleaning robots in public spaces, automatic holding proposal of resident-participatory city planning workshops, city landscape simulation by AI, multimodal optimization of intra-city mobility, automation of intra-city logistics, proposal of an energy local production for local consumption model, introduction of an urban water circulation system, construction of a smart security camera network, and city noise mapping and countermeasure proposal by AI, using the generative AI, and proposing the plan to a city manager. For example, it presents specific policy plans such as “food self-sufficiency rate improvement by promotion of urban agriculture”, “cost reduction by garbage collection route optimization by AI”, “expansion of renewable energy utilization by citizen-participatory energy sharing policy”, “safety and comfort improvement by IoT implementation in parks”, “damage status grasping by drone utilization during a disaster”, “nighttime safety improvement by smart streetlights”, “hygiene improvement of public spaces by automatic cleaning robots”, “democratization of city planning by resident-participatory workshops”, “balance optimization of landscape conservation and development by city landscape simulation by AI”, “traffic congestion mitigation by multimodal mobility optimization”, “delivery efficiency improvement by automation of intra-city logistics”, “sustainable city operation by energy local production for local consumption model”, “water resource conservation by introduction of urban water circulation system”, “public security improvement by smart security camera network”, and “living environment improvement by city noise mapping and countermeasure proposal by AI”. Furthermore, using the generative AI, it is also possible to personalize and automatically generate new ideas and policies for sustainable development of the city and resident service improvement according to a situation of the city and resident needs. Specifically, the creative city policy generation unit executes a hybrid generation engine combining an evolutionary algorithm and a large language model. Input data to the engine is a feature vector indicating a current issue of the city and a parameter matrix extracted from a past policy database. Specific examples of the input data include a numerical vector indicating an aging rate and a financial deficit amount, and tensor data indicating cost and effect of a past smart streetlight introduction project. The creative city policy generation unit generates an initial policy candidate population using the input data. The creative city policy generation unit executes fitness evaluation using a language model for each candidate. Output data from the engine is a text description of an optimized new policy and an array of probability scores indicating feasibility thereof. Specific examples of the output data include text data “public space management integrating an automatic cleaning robot and a security camera” and a numerical value of a feasibility score of 0.88. The creative city policy generation unit adds the output policy data to a proposal list of the user interface unit. The user interface unit displays a prompt requesting approval of an administrator. This processing method is fundamentally different from a conventional policy-making process in which humans repeat discussions in a meeting room. The system mathematically integrates genetic search in a vast parameter space and context understanding of natural language. Thereby, the system generates an innovative policy not bound by human bias at high speed. The system significantly reduces lead time for policy-making. This technology is applicable to management strategy formulation of a company and concept design of a new product. The system can also adopt a configuration of attempting to escape from a local optimal solution using simulated annealing. The system predicts an economic ripple effect of the generated policy by a Monte Carlo method.

The user interface unit provides a dashboard, a notification function, a feedback input function, a report sharing function, an alert notification function, a policy plan approval/rejection function, an information transmission function for residents, and the like that allow a city manager and an administrative official to intuitively operate instructions for information collection, browsing of analysis results and reports, selection of decision-making plans, confirmation and approval of business efficiency improvement tasks, receipt and evaluation of creativity support hints, confirmation of feedback from residents, sharing and discussion of policy plans, feedback input to the system, and the like. For example, it can be configured such that the latest city data summarization, recommended decision-making plans, ongoing business efficiency improvement tasks, hints for creativity improvement, complaints and requests from residents, approval status of policy plans, and the like can be confirmed at a glance on a dashboard screen. Specifically, the user interface unit executes a three-dimensional rendering engine using a web graphics library and an asynchronous communication module. Input data to the rendering engine is three-dimensional model data of the city and a real-time sensor value array acquired from the database management unit. Specific examples of the input data include an array of vertex coordinates defining polygons of buildings and numerical data of color codes indicating traffic volume in each area. The user interface unit transfers the input data to a video memory of a graphics processing unit. The user interface unit executes a shader program to draw a screen. Output data from the user interface unit is a two-dimensional array of pixel color values transmitted to a display device. A specific example of the output data includes red, green, and blue luminance value data for each pixel of 4K resolution. The user interface unit acquires coordinate data of a touch operation or a mouse click from the user. The user interface unit converts the coordinate data into a corresponding system command and transmits it to a backend server. This processing method advances a conventional interface that displays a static two-dimensional graph. The system visually maps a vast amount of city data using hardware acceleration. Thereby, the system improves a situation grasping speed of the manager. The system prevents a delay in decision-making due to intuitive operation. This technology is applicable to a radar display system for air traffic control and a digital twin environment of a large-scale plant. The system can also adopt a configuration that supports stereoscopic video output to a virtual reality headset. The system analyzes line-of-sight data of the user and dynamically arranges an important alert at the center of a visual field.

The database management unit centrally stores and manages all data, such as external and internal information acquired by the city data collection unit, summarization and analysis results generated by the analysis unit, tasks and policy plans generated by the operation support unit, hints and ideas generated by the creative city policy generation unit, feedback and approval history input in the user interface unit, and report history from residents, and realizes information deduplication, version management, access authority management, backup, search optimization, data lifecycle management, data anonymization and masking, data quality evaluation, and the like. Specifically, the database management unit executes a hybrid storage engine integrating a distributed relational database and a non-relational database. Input data to the storage engine is an execution request of a structured query language or a write request in a key-value store format transmitted asynchronously from each processing unit. Specific examples of the input data include character string data of an insert statement for inserting time-series data of a sensor and binary object data for storing unstructured text. The database management unit analyzes a schema of the input data. The database management unit routes the data to an optimal storage node according to characteristics of the data. Output data from the storage engine is a record set indicating an execution result of a query or a status code indicating completion of writing. Specific examples of the output data include data in a table format including an average value of environmental data in a specific period and an integer value 200 indicating processing success. The database management unit returns the output data to a requesting module. The database management unit executes data compression and index reconstruction as a background process. This processing method eliminates a conventional data management method depending on a single database server. The system automatically executes data sharding and replication. Thereby, the system dramatically improves throughput of data reading and writing. The system minimizes a risk of data loss during a hardware failure. This technology is applicable to a backend of a large-scale e-commerce site and a transaction processing system of a financial institution. The system can also adopt a configuration that enhances data tamper resistance using blockchain technology. The system performs hierarchical storage management that automatically migrates data with low access frequency to cold storage.

The security management unit implements user authentication, access control, communication encryption, data anonymization and masking, operation log recording, unauthorized access detection, information leakage prevention measures, automatic alerts upon occurrence of a security incident, strict security policy application for resident information and administrative confidential information, real-time response to external attacks, system vulnerability diagnosis, regular security audits, and the like in order to ensure information security of the entire system. Specifically, the security management unit executes a dynamic access control module based on a zero-trust architecture and an abnormal communication detection model using machine learning. Input data to the abnormal communication detection model is packet header information of network traffic flowing in the system and a statistical feature vector of a payload. Specific examples of the input data include numerical data indicating a source internet protocol address, a port number, and a packet size, and an integer value indicating the number of connection requests per unit time. The security management unit inputs the input data to a deep neural network. The security management unit calculates a normality score of the traffic. Output data from the model is a floating-point number indicating a threat level for each communication session and a blocking determination flag. Specific examples of the output data include a high numerical value of a threat level of 0.95 and truth value data for immediately disconnecting communication. When the blocking determination flag is true, the security management unit dynamically rewrites an access control list of a firewall. The security management unit physically discards the corresponding communication packet. This processing method is fundamentally different from conventional static security measures depending on perimeter defense. The system mathematically executes verification and monitoring at all times even for communication in an internal network. Thereby, the system prevents information leakage due to an unknown cyberattack or internal fraud. The system shortens response time to a security incident to a millisecond unit. This technology is applicable to a confidential information management system of a government agency and an electronic medical record network of a medical institution. The system can also adopt a configuration that ensures safety of a data transmission path using quantum cryptographic communication technology. The system automatically deploys a honeypot on a virtual network to collect behavior patterns of an attacker.

As described above, in the embodiment of the present invention, the city data collection unit, the city data analysis unit, the city operation support unit, the creative city policy generation unit, the user interface unit, the database management unit, and the security management unit operate in cooperation with each other, and function as an advanced smart city integrated operation support system that comprehensively and automatically realizes optimization of city operation, business efficiency improvement, enhancement of disaster response capability, environmental conservation, advancement of resident services, sustainable development of the city, and improvement of safety, comfort, and creativity of the city, with the generative AI at the core. Specifically, the system adopts a distributed computing architecture composed of a plurality of computing nodes. The system containerizes each unit as a microservice. The system dynamically scales each unit using a container orchestration tool. The system executes the generative AI having a large language model as a core on a GPU cluster. The system acquires multidimensional time-series tensor data through the city data collection unit. The system executes a transformer model having a self-attention mechanism in the city data analysis unit. The system executes a reinforcement learning agent in the city operation support unit. The system executes a generative adversarial network in the creative city policy generation unit. The system links these AI models. The system constructs a digital twin in which a physical space of the city is replicated in a digital space. The system executes simulations of various policies on the digital twin. The system determines an optimal city operation policy based on simulation results. The system transmits the determined policy to a control system of city infrastructure. The system directly controls physical operations of the city infrastructure. Thereby, the system shortens a delay in city operation to a millisecond unit. The system continuously executes optimization of the city without human intervention. The system minimizes energy consumption of the city. The system prevents traffic congestion. The system minimizes damage during a disaster. The system realizes autonomous operation of a smart city by these technical effects. The system is applied to a large-scale ordinance-designated city and an emerging smart city development project.

### (System Configuration)

The system according to the present embodiment includes a city data collection unit, a city data analysis unit, a city operation support unit, a creative city policy generation unit, a user interface unit, a database management unit, and a security management unit. The city data collection unit has a function of automatically and cross-sectionally collecting data related to city operation from various information sources inside and outside the city, and acquires traffic data such as traffic volume sensors on major roads and intersections, operating status of traffic lights, operation status APIs of public transportation, delay information of buses and railways, operation data of shared bicycles and car sharing, availability of parking lots, and taxi dispatch data in real time, acquires energy data such as power consumption of the entire city, power generation amount of renewable energy, operating status of storage batteries, consumption peaks of each facility, usage amounts of gas and water, energy supply and demand balance, and abnormality detection data of a power system from an electric power company or a city infrastructure API, further acquires environmental data such as particulate concentration in the atmosphere, carbon dioxide concentration, temperature, humidity, noise level, river water level, rainfall amount, ultraviolet ray amount, soil pollution data, and indicators of an urban heat island phenomenon from an IoT sensor or a weather API, automatically collects disaster prevention data such as occurrence information of earthquakes and typhoons, tsunami warnings, operating status of evacuation shelters, damage reports during disasters, disaster-related posts on SNS, fire and emergency dispatch history, landslide warning information, and lifeline damage status, acquires administrative data such as congestion status of counters, the number of applications for administrative procedures, the number of inquiries from residents, usage status of administrative services, tax revenue and budget execution status, operation rates of public facilities, and participation status in administrative events from an administrative system API, automatically collects resident feedback such as delays in garbage collection, road cave-ins, noise complaints, defect reports of public facilities, resident satisfaction questionnaires, posts related to municipal administration on SNS, and reports from resident applications, centrally stores all these data in a database on a server, and automatically performs deduplication, metadata addition, data normalization, automatic detection of anomaly values, and data quality evaluation. Specifically, the city data collection unit executes cooperative processing of an edge computing device and a cloud server. The city data collection unit receives streaming data from millions of IoT sensors arranged in the city. The city data collection unit temporarily holds the received data in a message queuing system. The city data collection unit parses the data in real time using a stream processing engine. The city data collection unit formats the traffic data as a three-dimensional time-series tensor. The city data collection unit formats the energy data as a one-dimensional time-series vector. The city data collection unit formats the environmental data as a four-dimensional tensor including spatial coordinates. The city data collection unit formats the disaster prevention data as a natural language text vector. The city data collection unit formats the administrative data as structured relational data. The city data collection unit formats the resident feedback as unstructured text data. The city data collection unit maps these heterogeneous data to a common latent space. The city data collection unit interpolates missing values of the data using a multimodal learning model. The city data collection unit executes an isolation forest as an anomaly detection algorithm. The city data collection unit smoothes sensor data including noise. The city data collection unit writes the preprocessed data to a distributed database. The city data collection unit eliminates duplication using a hash function when writing the data. The city data collection unit adds a time stamp and a geotag to the data. The city data collection unit applies Z-score normalization as data normalization processing. Thereby, the city data collection unit improves inference accuracy of a subsequent AI model. The city data collection unit reduces a delay in data collection to the utmost limit. The city data collection unit optimizes consumption of a network bandwidth. The city data collection unit is applied to a traffic control system and a smart grid management system.

The city data analysis unit applies natural language processing using a generative AI, an anomaly detection algorithm, a machine learning model, time-series analysis, clustering, causal inference, and the like to a vast amount of data collected by the city data collection unit, and automatically executes summarization of various data, anomaly value detection, trend analysis, risk evaluation, resident needs extraction, future prediction, scenario analysis, and the like. For example, it detects anomalies such as “traffic congestion twice as much as usual occurs on major arterial roads”, “delays in public transportation tend to expand”, and “taxi demand rapidly increases in a specific area” from the traffic data, extracts trends and anomalies such as “power consumption records a record high”, “renewable energy ratio increases”, “gas consumption rapidly increases”, and “water leakage is detected” from the energy data, identifies risks and issues such as “particulate concentration in the atmosphere exceeds a reference value”, “river water level reaches a warning level”, “noise complaints frequently occur in a specific area”, and “urban heat island phenomenon progresses” from the environmental data, extracts disaster risks and resident behaviors such as “damage reports rapidly increase after occurrence of an earthquake”, “congestion degree of evacuation shelters increases”, “disaster-related posts on SNS increase”, and “landslide warning area expands” from the disaster prevention data, extracts operational issues and improvement points such as “counter congestion concentrates on specific days of the week and time zones”, “usage rate of online applications increases”, “operation rate of public facilities decreases”, and “the number of participants in administrative events decreases” from the administrative data, extracts resident needs and issues such as “complaints regarding garbage collection delays increase”, “road cave-in reports frequently occur in a specific area”, “resident satisfaction tends to decrease”, and “administrative criticism on SNS increases” from the resident feedback, and further, the analysis result is automatically generated in a visual format such as text, a graph, a chart, a heat map, a word cloud, a time-series graph, a heat map on a map, a causal relationship diagram, and a future prediction graph that the user can intuitively understand, using a natural language generation function by the generative AI. Specific examples of prompt sentences to be read by the generative AI include “Please summarize the following city data and extract anomaly values and risk factors”, “Please list major issues from resident feedback of this one week”, “Please analyze traffic, energy, environment, disaster prevention, and administrative data and extract important trends in city operation”, and the like. Specifically, the city data analysis unit executes a multimodal large language model. The city data analysis unit receives a preprocessed multidimensional tensor as input data. The city data analysis unit receives, for example, a 128-dimensional traffic volume vector and a 256-dimensional environmental sensor time-series array as input data. The city data analysis unit receives a text embedding vector of resident feedback as input data. The city data analysis unit inputs these input data to an encoder of a transformer architecture. The city data analysis unit calculates a correlation between different data modalities using a self-attention mechanism. The city data analysis unit quantifies, for example, a causal relationship between traffic congestion and air pollution. The city data analysis unit generates a probability distribution of an anomaly score and a future prediction value as output data. The city data analysis unit outputs, for example, a congestion probability after one hour at a specific intersection as a percentage as output data. The city data analysis unit outputs a prediction curve of power demand as a time-series array as output data. The city data analysis unit outputs a sentiment score indicating a degree of dissatisfaction of residents as output data. The city data analysis unit transmits these output results to the subsequent city operation support unit. The city data analysis unit generates an immediate alert when the output result exceeds a predetermined threshold. The city data analysis unit uses city data for the past ten years as training data when learning the model. The city data analysis unit updates weights of the model using a backpropagation method. The city data analysis unit uses a combination of a cross-entropy error and a mean square error as a loss function. Thereby, the city data analysis unit realizes highly accurate prediction of complex city dynamics. The city data analysis unit detects signs of minute anomalies that cannot be discovered by a human analyst. The city data analysis unit brings about a technical effect of improving resilience of the city. The city data analysis unit is applied to formulation of a city plan and drafting of a disaster prevention plan.

The city operation support unit has a function of automatically generating an optimal policy plan necessary for city operation using the generative AI based on an output result of the city data analysis unit, and further automatically executing routine work in cooperation with a signal control system, a notification distribution system, a public transportation schedule adjustment system, an energy supply and demand adjustment system, an administrative procedure system, a disaster information distribution system, and the like. For example, when traffic congestion occurs, it proposes “signal control optimization for a congested section”, “increase in public transportation flights”, “guidance notification of a detour”, “priority control of taxi dispatch”, and the like, when energy consumption reaches a peak, it recommends “automatic distribution of a power saving request notification”, “utilization of storage batteries”, “consumption suppression of some facilities”, “priority utilization of renewable energy”, and the like, when environmental risks are increasing, it proposes “enhancement of operation of an air purification device”, “notification of refraining from going out to citizens”, “enhancement of river monitoring”, “identification of and countermeasures against a noise source”, and the like, when disaster risks are high, it recommends “preparation for opening evacuation shelters”, “notification of evacuation information to residents”, “grasping of damage status by a drone”, “optimization of fire and emergency dispatch”, and the like, and when congestion of administrative counters occurs, it proposes “expansion of online reservation slots”, “increase in counter staff”, “promotion of online procedures”, “congestion prediction notification to residents”, and the like, and for example, when traffic congestion is detected, it sends an automatic command to the signal control system to optimize time allocation of green lights, issues a flight increase command to the public transportation schedule adjustment system, automatically transmits a detour guidance notification to a smartphone application of a resident, when energy consumption reaches a peak, it automatically transmits a power saving request notification to the smartphone application of the resident, automatically controls charging and discharging of storage batteries, instructs priority utilization of renewable energy, and when disaster risks increase, it automatically updates an opening status of evacuation shelters, simultaneously distributes evacuation information to residents, automatically instructs grasping of damage status by a drone, and optimizes fire and emergency dispatch. Specific examples of prompt sentences to be read by the generative AI include “Please propose five optimal city operation policy plans based on the following city data analysis results”, “Please list measures to be implemented during this energy consumption peak”, “Please generate an optimal evacuation guidance plan upon occurrence of a disaster”, and the like. Specifically, the city operation support unit executes a deep reinforcement learning algorithm. The city operation support unit receives an anomaly score and a predicted probability distribution generated by the city data analysis unit as input data. The city operation support unit receives a state vector indicating a current operating state of city infrastructure as input data. The city operation support unit receives, for example, a current green light cycle time of a traffic light and a current charging rate of a storage battery as input data. The city operation support unit processes these input data in a framework of a Markov decision process. The city operation support unit calculates an optimal action value using a policy gradient method. The city operation support unit generates a sequence of specific control commands as output data. The city operation support unit outputs, for example, a control signal for extending a green light at a specific intersection by 15 seconds as output data. The city operation support unit outputs a control signal for reducing illuminance of streetlights in a specific area by 20 percent as output data. The city operation support unit outputs an API call of a flight increase request to an operation management system of public transportation as output data. The city operation support unit directly transmits these output data to a control system of each infrastructure. The city operation support unit receives feedback from the control system and calculates a reward function. The city operation support unit gives a positive reward when a congestion length decreases. The city operation support unit gives a positive reward when energy consumption falls below a target value. The city operation support unit continuously updates weights of a reinforcement learning model. Thereby, the city operation support unit improves adaptability to environmental changes. The city operation support unit autonomously controls infrastructure without intervention of a human operator. The city operation support unit eliminates a delay in control and realizes real-time optimization. The city operation support unit brings about a technical effect of maximizing energy efficiency of the entire city. The city operation support unit is applied to operation of a smart transportation network and a microgrid.

The creative city policy generation unit has a function of automatically generating a new and unprecedented city policy plan, such as promotion of urban agriculture, garbage collection route optimization by AI, citizen-participatory energy sharing, IoT implementation in parks, drone utilization during a disaster, introduction of smart streetlights, introduction of automatic cleaning robots in public spaces, automatic holding proposal of resident-participatory city planning workshops, city landscape simulation by AI, multimodal optimization of intra-city mobility, automation of intra-city logistics, proposal of a local production for local consumption model of energy, introduction of an urban water circulation system, construction of a smart security camera network, and city noise mapping and countermeasure proposal by AI, using the generative AI, and proposing the plan to a city manager, and presents specific policy plans such as, for example, “improvement of food self-sufficiency rate by promotion of urban agriculture”, “cost reduction by garbage collection route optimization by AI”, “expansion of renewable energy utilization by citizen-participatory energy sharing policies”, “improvement of safety and comfort by IoT implementation in parks”, “grasping of damage status by drone utilization during a disaster”, “improvement of nighttime safety by smart streetlights”, “improvement of hygiene in public spaces by automatic cleaning robots”, “democratization of city planning by resident-participatory workshops”, “balance optimization of landscape conservation and development by city landscape simulation by AI”, “traffic congestion mitigation by optimization of multimodal mobility”, “delivery efficiency improvement by automation of intra-city logistics”, “sustainable city operation by a local production for local consumption model of energy”, “water resource conservation by introduction of an urban water circulation system”, “security improvement by a smart security camera network”, and “living environment improvement by city noise mapping and countermeasure proposal by AI”, and can further automatically generate new ideas and policies for sustainable development of the city and improvement of resident services by personalizing them according to the situation of the city and resident needs using the generative AI. Specific examples of prompt sentences to be read by the generative AI include “Please generate 10 new policy plans for sustainable development of the city”, “Please list creative ideas for improving resident services”, “Please propose a city design plan that achieves both city landscape and convenience”, and the like. Specifically, the creative city policy generation unit executes a composite AI architecture combining a large language model and a diffusion model. The creative city policy generation unit receives long-term trend data of the city and a text vector indicating potential needs of residents as input data. The creative city policy generation unit receives, for example, a demographic tensor for the past five years and a time-series array of environmental changes as input data. The creative city policy generation unit receives three-dimensional topographic data of the city and a spatial coordinate matrix of existing infrastructure as input data. The creative city policy generation unit processes these input data by a prompt engineering module. The creative city policy generation unit generates a conceptual text description of a policy using the large language model. The creative city policy generation unit generates a simulation image of a city landscape after introduction of the policy using the diffusion model. The creative city policy generation unit outputs structured data indicating an execution procedure of the policy as output data. The creative city policy generation unit outputs a numerical matrix indicating cost-effectiveness of the policy as output data. The creative city policy generation unit outputs, for example, a predicted harvest amount and a predicted value of a carbon dioxide reduction amount upon introduction of urban agriculture as output data. The creative city policy generation unit inputs an output result to a subsequent simulation engine. The creative city policy generation unit verifies feasibility of the policy using the simulation engine. The creative city policy generation unit automatically corrects the policy plan based on a verification result. The creative city policy generation unit uses a database of successful smart city cases around the world in learning the model. The creative city policy generation unit adapts the model to characteristics of a specific city using a fine-tuning technology. Thereby, the creative city policy generation unit creates an innovative policy exceeding limits of human ideas. The creative city policy generation unit brings about a technical effect of dramatically speeding up a formulation process of a city plan. The creative city policy generation unit is applied to a next-generation city development project and a regional revitalization business.

The user interface unit provides a dashboard, a notification function, a feedback input function, a report sharing function, an alert notification function, a policy plan approval/rejection function, an information transmission function for residents, and the like that allow a city manager and an administrative official to intuitively operate instructions for information collection, browsing of analysis results and reports, selection of decision-making plans, confirmation and approval of business efficiency improvement tasks, receipt and evaluation of creativity support hints, confirmation of feedback from residents, sharing and discussion of policy plans, feedback input to the system, and the like, and can be configured such that, for example, the latest city data summarization, recommended decision-making plans, ongoing business efficiency improvement tasks, hints for creativity improvement, complaints and requests from residents, approval status of policy plans, and the like can be confirmed at a glance on a dashboard screen. Specifically, the user interface unit is implemented as a single-page application. The user interface unit establishes a constant connection with a server using WebSocket communication. The user interface unit receives real-time data push-distributed from the server. The user interface unit immediately reflects the received data on a virtual document object model of a browser. The user interface unit draws a three-dimensional city digital twin using WebGL technology. The user interface unit maps various indicators of the city onto a three-dimensional space as changes in color and height. The user interface unit captures an operation event such as a line-of-sight movement of the user or a mouse click. The user interface unit transmits the operation event to the server by asynchronous communication. The user interface unit displays a prediction result and a policy plan returned from the server as a pop-up window. The user interface unit provides a chatbot function incorporating a natural language processing model. The user interface unit analyzes a query in a natural language from the user. The user interface unit automatically generates a search query of a database corresponding to the query. The user interface unit renders a search result as a dynamic graph or chart. The user interface unit records an operation history of the user as log data. The user interface unit estimates a region of interest of the user by machine learning using the log data. The user interface unit automatically optimizes a layout of the dashboard based on an estimation result. Thereby, the user interface unit dramatically improves visibility and operability of information. The user interface unit brings about a technical effect of reducing a cognitive load required for decision-making. The user interface unit is applied to an integrated control center of a city and a monitor system of a disaster response headquarters.

The database management unit centrally stores and manages all data, such as external and internal information acquired by the city data collection unit, summarization and analysis results generated by the analysis unit, tasks and policy plans generated by the operation support unit, hints and ideas generated by the creative city policy generation unit, feedback and approval histories input in the user interface unit, and report histories from residents, and realizes data deduplication, version management, access authority management, backup, search optimization, data lifecycle management, data anonymization and masking, data quality evaluation, and the like. Specifically, the database management unit constructs a hybrid data lake combining a distributed NoSQL database and a relational database. The database management unit executes a time-series database engine specialized for storing time-series data. The database management unit constructs an inverted index to speed up a search for unstructured text data. The database management unit implements an approximate nearest neighbor search algorithm to perform a similarity search for vector data. The database management unit determines duplicate records at high speed using a Bloom filter when writing data. The database management unit adopts an append-only log-structured merge-tree for data version management. The database management unit dynamically updates a role-based access control list for access authority management. The database management unit executes data backup processing as an asynchronous replication process. The database management unit automatically migrates old data to cold storage as data lifecycle management. The database management unit applies a k-anonymity algorithm as data anonymization processing. The database management unit converts a field including personal information into an irreversible hash value. The database management unit periodically executes statistical profiling for data quality evaluation. The database management unit calculates a ratio of missing values and a frequency of outliers. The database management unit automatically starts a data cleansing batch when a quality score falls below a threshold value. The database management unit thereby makes petabyte-class city data searchable with a latency in milliseconds. The database management unit brings about a technical effect of optimizing storage costs. The database management unit is applied to a large-scale administrative data infrastructure and an open data platform.

The security management unit implements user authentication, access control, communication encryption, data anonymization and masking, operation log recording, unauthorized access detection, information leakage prevention measures, automatic alerts upon occurrence of a security incident, strict security policy application for resident information and administrative confidential information, real-time response to external attacks, system vulnerability diagnosis, periodic security audits, and the like in order to ensure information security of the entire system. Specifically, the security management unit executes an authentication and authorization infrastructure based on a zero-trust architecture. The security management unit requires a combination of multi-factor authentication and biometric authentication in user authentication. The security management unit operates an attribute-based dynamic policy evaluation engine in access control. The security management unit uses a TLS protocol and an elliptic curve cryptography algorithm for communication encryption. The security management unit applies an AES 256-bit encryption method for encrypting stored data. The security management unit generates a tamper-proof audit trail using blockchain technology in operation log recording. The security management unit executes a deep learning-based intrusion detection system for unauthorized access detection. The security management unit extracts a packet header of network traffic as a time-series tensor. The security management unit calculates a deviation from a normal communication pattern as an anomaly score using an autoencoder model. The security management unit automatically blocks communication from a corresponding IP address with a firewall when the anomaly score exceeds a threshold value. The security management unit executes a data loss prevention agent at each endpoint as an information leakage prevention measure. The security management unit blocks external transmission of confidential information in real time. The security management unit executes an automated incident response playbook upon occurrence of a security incident. The security management unit incorporates system vulnerability diagnosis into a continuous integration pipeline. The security management unit thereby improves a self-healing capability of the system against cyberattacks. The security management unit brings about a technical effect of minimizing a risk of city infrastructure stoppage. The security management unit is applied to a control system for critical infrastructure and a core administrative system.

In this way, the system according to the present embodiment functions as an advanced smart city integrated operation support system in which the city data collection unit, the city data analysis unit, the city operation support unit, the creative city policy generation unit, the user interface unit, the database management unit, and the security management unit operate in cooperation with each other, with the generative AI at the core, to comprehensively and automatically realize optimization of city operation, business efficiency improvement, strengthening of disaster response capability, environmental conservation, sophistication of resident services, sustainable development of the city, and improvement of safety, comfort, and creativity of the city. Specifically, the system couples the components with each other by high-speed remote procedure calls. The system adopts an event-driven architecture and links data by asynchronous messaging. The system dynamically distributes inference processing of the generative AI between an edge device and a cloud. The system autonomously optimizes allocation of computing resources in accordance with a change in a situation of the city. The system inputs a multidimensional tensor acquired by the city data collection unit into a processing pipeline in real time. The system executes feature extraction in a high-dimensional space by a transformer model in the city data analysis unit. The system derives an optimal control policy by reinforcement learning in the city operation support unit. The system synthesizes a new policy by a generative adversarial network in the creative city policy generation unit. The system three-dimensionally visualizes these AI processing results through the user interface unit. The system persists petabyte-class data in a distributed storage in the database management unit. The system protects a communication path using quantum-resistant cryptography in the security management unit. The system completes these processes with a latency in milliseconds without human intervention. The system completely synchronizes physical infrastructure of the city and a digital space. The system maximizes energy efficiency of the entire city to the utmost limit. The system optimizes traffic flow based on a fluid dynamics model and completely eliminates traffic congestion. The system dramatically reduces operation costs of the city by these technical effects. The system is applied to a national-level smart city concept and an integrated management platform of a wide-area local government.

### (Implementation Steps)

### Step 1: Multidimensional Real-time Collection of City Data

The city data collection unit automatically and cross-sectionally collects, in real time, traffic data such as traffic sensors on major roads and intersections, operating status of traffic lights, public transportation operation APIs, delay information of buses and railways, operation data of shared bicycles and car sharing, availability of parking lots, and taxi dispatch data; energy data such as power consumption of the entire city, power generation amount of renewable energy, operating status of storage batteries, consumption peaks of respective facilities, usage amounts of gas and water, energy supply and demand balance, and anomaly detection data of a power system; environmental data such as fine particulate concentration in the atmosphere, carbon dioxide concentration, temperature, humidity, noise level, river water level, rainfall amount, ultraviolet ray amount, soil pollution data, and indicators of an urban heat island phenomenon; disaster prevention data such as occurrence information of earthquakes and typhoons, tsunami warnings, operating status of evacuation shelters, damage reports during disasters, disaster-related posts on SNS, fire and emergency dispatch histories, sediment disaster warning information, and lifeline damage status; administrative data such as congestion status of counters, number of applications for administrative procedures, number of inquiries from residents, usage status of administrative services, tax revenue and budget execution status, operation rates of public facilities, and participation status in administrative events; and resident feedback such as delays in garbage collection, road cave-ins, noise complaints, defect reports of public facilities, resident satisfaction questionnaires, posts related to municipal administration on SNS, and reports from resident applications, centrally stores the collected data in a database on a server, and automatically performs deduplication, metadata addition, data normalization, automatic detection of anomaly values, and data quality evaluation. Specifically, in this step, the city data collection unit starts a distributed stream processing framework. The city data collection unit establishes a persistent connection by an MQTT protocol with millions of IoT endpoints. The city data collection unit receives a numerical array of vehicle speeds and inter-vehicle distances from a traffic sensor at a frequency of 100 times per second. The city data collection unit acquires a time-series vector of power consumption from a smart meter in milliseconds. The city data collection unit collects floating-point data of temperature and fine particulate concentration from an environmental sensor as a multidimensional tensor. The city data collection unit fetches numerical values of seismic intensity and water level from a disaster prevention system in real time. The city data collection unit extracts a transaction log from an administrative database as structured data. The city data collection unit acquires posted text of residents from a streaming API of SNS as a natural language vector. The city data collection unit temporarily stores these heterogeneous data in an in-memory data grid. The city data collection unit instantaneously discards duplicate data with the same timestamp using a hash function. The city data collection unit adds GPS coordinates and a high-precision timestamp to each data point as metadata. The city data collection unit applies min-max scaling as data normalization processing to unify a value range from zero to one. The city data collection unit automatically excludes outliers caused by sensor failures using a statistical anomaly detection algorithm. The city data collection unit calculates a missing rate as data quality evaluation and reconnects a data stream exceeding a threshold value. The city data collection unit thereby continuously supplies a high-quality dataset optimal for subsequent AI processing. The city data collection unit brings about a technical effect of eliminating a bottleneck in data collection. The city data collection unit is applied to a data integration infrastructure of a wide-area sensor network.

### Step 2: Preprocessing and Organization of City Data

For a vast amount of data collected by the city data collection unit, deduplication, classification by information source, addition of metadata such as acquisition date and time, related keywords, and information reliability, data normalization, automatic detection of anomaly values, and data quality evaluation are automatically executed to improve efficiency and accuracy of subsequent analysis processing. Specifically, in this step, the city data collection unit executes a data conversion pipeline using a parallel distributed processing engine. The city data collection unit expands input raw data into a data frame on a memory. The city data collection unit applies a Bloom filter for deduplication to reduce a calculation amount. The city data collection unit executes a text classification model using a support vector machine in classification processing by information source. The city data collection unit extracts a named entity from text data using a natural language processing model and adds the named entity as a related keyword. The city data collection unit applies a Bayesian estimation algorithm based on a past data accuracy history to calculate information reliability. The city data collection unit performs Z-score conversion on continuous value data so as to follow a standard normal distribution in data normalization. The city data collection unit executes calculation of a reconstruction error using an autoencoder in automatic detection of anomaly values. The city data collection unit flags a data point whose reconstruction error exceeds a predetermined threshold value as an anomaly value. The city data collection unit automatically executes a script for verifying completeness and consistency of each data batch in data quality evaluation. The city data collection unit converts preprocessed data into a column-oriented storage format and saves the data in a data lake. The city data collection unit thereby dramatically improves a data reading speed. The city data collection unit brings about a technical effect of accelerating a convergence speed of a subsequent machine learning model. The city data collection unit is applied to an ETL processing process of a large-scale data warehouse.

### Step 3: City Data Summarization, Anomaly Detection, and Trend Analysis by Generative AI

The city data analysis unit applies natural language processing using a generative AI, an anomaly detection algorithm, a machine learning model, time-series analysis, clustering, causal inference, and the like to a large amount of collected and organized city data, automatically executes summarization of various data, anomaly value detection, trend analysis, risk evaluation, resident needs extraction, future prediction, scenario analysis, and the like, and automatically generates an analysis result in a visual format such as text, a graph, a chart, a heat map, a word cloud, a time-series graph, a heat map on a map, a causal relationship diagram, and a future prediction graph. Specific examples of prompt sentences to be read by the generative AI include “Please summarize the following city data and extract anomaly values and risk factors”, “Please list major issues from resident feedback over the past week”, and “Please analyze traffic, energy, environment, disaster prevention, and administrative data and extract important trends in city operation”. Specifically, in this step, the city data analysis unit executes a multimodal large language model having billions of parameters on a GPU cluster. The city data analysis unit receives a preprocessed traffic volume tensor and a time-series array of environmental data as input data. The city data analysis unit receives, for example, a matrix of the number of passing vehicles for each intersection over the past 24 hours as input data. The city data analysis unit receives an embedding vector of complaint text from residents as input data. The city data analysis unit inputs these input data into an encoder layer of a transformer and extracts feature amounts by a self-attention mechanism. The city data analysis unit executes a long short-term memory network as an anomaly detection algorithm and calculates a divergence between a predicted value and an actual measurement value of time-series data. The city data analysis unit executes DBSCAN as a clustering algorithm and specifies a spatial anomaly occurrence area. The city data analysis unit calculates, for example, a correlation coefficient between rainfall amount and traffic congestion using a causal inference model. The city data analysis unit generates summary text indicating a current status of the city as output data. The city data analysis unit generates an image tensor of a heat map indicating an anomaly occurrence probability as output data. The city data analysis unit generates coordinate data of a time-series graph indicating a future power demand prediction as output data. The city data analysis unit transmits an output result to the subsequent city operation support unit in a JSON format. The city data analysis unit uses a pair of past city data and an expert analysis report as training data in model learning. The city data analysis unit thereby discovers a hidden pattern from data of a scale that cannot be processed by humans. The city data analysis unit brings about a technical effect of improving accuracy of decision-making in city operation. The city data analysis unit is applied to a comprehensive monitoring center and a crisis management dashboard of a city.

Step 4: Automatic Generation of Optimal City Operation Policy Plan and Business Automation by Generative AI

The city operation support unit automatically generates an optimal policy plan necessary for city operation using the generative AI based on an output result of the city data analysis unit, and automatically executes routine work in cooperation with a signal control system, a notification distribution system, a public transportation schedule adjustment system, an energy supply and demand adjustment system, an administrative procedure system, a disaster information distribution system, and the like. For example, when traffic congestion occurs, it proposes “signal control optimization for a congested section”, “increase in public transportation flights”, “detour guidance notification”, “priority control of taxi dispatch”, and the like; when energy consumption reaches a peak, it recommends “automatic distribution of a power saving request notification”, “utilization of storage batteries”, “consumption suppression of some facilities”, “priority use of renewable energy”, and the like; and when a disaster risk is high, it recommends “preparation for opening evacuation shelters”, “evacuation information notification to residents”, “damage situation grasping by drones”, “optimization of fire and emergency dispatch”, and the like. Specific examples of prompt sentences to be read by the generative AI include “Please propose five optimal city operation policy plans based on the following city data analysis results”, “Please list measures to be implemented during this energy consumption peak”, and “Please generate an optimal evacuation guidance plan upon occurrence of a disaster”. Specifically, in this step, the city operation support unit executes a hybrid inference engine linking a deep reinforcement learning model and a large language model. The city operation support unit receives a vector of an anomaly score and a predicted probability distribution output from the city data analysis unit as input data. The city operation support unit receives a state tensor indicating an operating parameter of current city infrastructure as input data. The city operation support unit receives, for example, a numerical array of a signal cycle time of each intersection and an accommodatable number of people of each evacuation shelter as input data. The city operation support unit inputs these input data into a neural network of a reinforcement learning agent. The city operation support unit calculates a probability distribution of an optimal control action using a policy gradient method. The city operation support unit generates natural language text explaining an intention of the control action using the large language model. The city operation support unit outputs an API request for green light extension to the signal control system as output data. The city operation support unit outputs payload data of a push notification to a smartphone of a resident as output data. The city operation support unit outputs, for example, a control command of “reduce power in a specific area by 10 percent” as output data. The city operation support unit transmits these output data to each external system by asynchronous communication. The city operation support unit receives an execution result from the external system as feedback and calculates a reward function. The city operation support unit updates weights of the model in real time so as to maximize a reward. The city operation support unit thereby realizes autonomous optimal control of city infrastructure. The city operation support unit brings about a technical effect of eliminating a time lag due to human intervention and improving responsiveness. The city operation support unit is applied to supply and demand adjustment of a smart grid and an advanced traffic control system.

Step 5: Automatic Generation of Creative City Policy Plan by Generative AI

The creative city policy generation unit automatically generates a new and unprecedented city policy plan, such as promotion of urban agriculture, garbage collection route optimization by AI, citizen-participatory energy sharing, IoT implementation in parks, drone utilization during a disaster, introduction of smart streetlights, introduction of automatic cleaning robots in public spaces, automatic holding proposal of resident-participatory city planning workshops, city landscape simulation by AI, multimodal optimization of intra-city mobility, automation of intra-city logistics, proposal of an energy local production for local consumption model, introduction of an urban water circulation system, construction of a smart security camera network, and city noise mapping and countermeasure proposal by AI, using the generative AI, and proposes the plan to a city manager. Specific examples of prompt sentences to be read by the generative AI include “Please generate 10 new policy plans for sustainable development of the city”, “Please list creative ideas for improving resident services”, and “Please propose a city design plan that achieves both city landscape and convenience”. Specifically, in this step, the creative city policy generation unit executes a generation pipeline combining a generative adversarial network and a large language model. The creative city policy generation unit receives a long-term demographic prediction vector of the city and a time-series tensor of environmental changes as input data. The creative city policy generation unit receives vertex coordinate data of a three-dimensional spatial model of the city as input data. The creative city policy generation unit receives a text embedding vector indicating potential requests of residents as input data. The creative city policy generation unit embeds these input data into a prompt template and inputs the prompt template into the large language model. The creative city policy generation unit generates a conceptual design document of a new policy as structured data using the large language model. The creative city policy generation unit generates a simulation image of a city landscape after policy introduction using a generator of the generative adversarial network. The creative city policy generation unit evaluates reality of the generated image using a discriminator and updates weights of the generator. The creative city policy generation unit outputs a task list indicating specific execution steps of the policy as output data. The creative city policy generation unit outputs a numerical matrix indicating an expected economic effect and environmental load reduction amount of the policy as output data. The creative city policy generation unit outputs, for example, a predicted value of “30 percent reduction in power consumption by introducing smart streetlights” as output data. The creative city policy generation unit saves an output result in the database management unit and transmits the output result to the user interface unit. The creative city policy generation unit thereby automatically drafts an innovative city plan that is not on an extension of the past. The creative city policy generation unit brings about a technical effect of dramatically improving sustainability of the city. The creative city policy generation unit is applied to basic plan formulation of a next-generation smart city and an urban redevelopment project.

### Step 6: Automatic Generation of City Operation Report, User Presentation, and Feedback Acquisition

Respective units operate in cooperation with each other to automatically generate a city operation report integrating a city data collection result, an analysis result, decision-making support content, business efficiency improvement progress, and creativity improvement support content, and present the report to a city manager and an administrative person in charge through the user interface unit. A user can confirm at a glance a latest city data summary, a recommended decision-making plan, an ongoing business efficiency improvement task, hints for creativity improvement, complaints and requests from residents, an approval status of a policy plan, and the like on a dashboard screen, and can further input comments and feedback on report content, share the report content with related departments, automatically generate a new task and a meeting based on the report content, and the like. Specifically, in this step, the system executes a report generation engine as a background process. The system asynchronously acquires structured data and unstructured data indicating a processing result of each step from the database management unit. The system automatically generates summary text explaining numerical data and graph data using a natural language generation model. The system binds the acquired data and the generated text to a dynamic web template based on HTML5 and CSS3. The system distributes the dashboard screen rendered through the user interface unit to a client terminal. The system draws a three-dimensional city digital twin on the dashboard and superimposes and displays an anomaly occurrence location as a red heat map. The system captures a mouse click and a keyboard input from the user with an event listener. The system analyzes feedback text input by the user with a natural language processing model and calculates a sentiment score. The system immediately transmits a corresponding control command to an infrastructure control system when the user approves the policy plan. The system accumulates an operation history and an approval pattern of the user in a database as a dataset for retraining a machine learning model. The system automatically schedules an online meeting among related parties in cooperation with a calendar system based on the report content. The system thereby constructs a seamless cooperative work environment between the city manager and an AI system. The system brings about a technical effect of converting a decision-making process into a data-driven type and maximizing business efficiency. The system is applied to a policy decision meeting of a local government and daily monitoring work of city operation.

### (Specific Use Case)

For example, assume a case where a city manager utilizes the system of the present invention for the purpose of optimizing the operation of the entire city during a large-scale summer event. In this case, the city data collection unit acquires traffic data such as traffic sensors around the event venue and the entire city, public transportation operation APIs, bus and railway delay information, share cycle and car share operation data, parking lot availability, and taxi dispatch data in real time, further collects energy data such as power consumption, renewable energy power generation, storage battery operation status, consumption peaks of each facility, and gas and water usage, environmental data such as temperature, humidity, atmospheric particulate concentration, noise level, river water level, and rainfall, disaster prevention data such as earthquakes, typhoons, evacuation shelter operation status, disaster damage reports, SNS disaster-related posts, and fire and emergency dispatch histories, administrative data such as counter congestion status, the number of administrative procedure applications, the number of resident inquiries, administrative service usage status, public facility operation rates, and event participation status, and resident feedback such as garbage collection delays, road cave-ins, noise complaints, public facility defect reports, resident satisfaction questionnaires, SNS municipal administration posts, and resident application reports in parallel, and centrally stores them in a database on a server. The city data analysis unit automatically executes summarization, anomaly detection, and trend analysis of, for example, “identification of traffic congestion occurrence areas during the event period”, “extraction of delay patterns of public transportation”, “prediction of power consumption peaks”, “increase in air pollution risk”, “frequent occurrence areas of noise complaints”, “transition of evacuation shelter congestion degree”, and “declining trend of resident satisfaction” for these vast amounts of data using the generative AI, and generates an analysis result in a visual format such as a time-series graph, a heat map, a word cloud, and a causal relationship diagram. Specific examples of prompt sentences to be read by the generative AI include “Please summarize the following city data and extract anomaly values and risk factors during the event period”, “Please list major event-related issues from resident feedback over the past week”, and “Please analyze traffic, energy, environment, disaster prevention, and administrative data and extract important trends in event operation”. The city operation support unit automatically generates policy plans such as “signal control optimization for congested sections”, “temporary increase in public transportation services”, “automatic distribution of detour guidance notifications”, “power saving request notification during power consumption peaks”, “evacuation shelter opening preparation and congestion prediction notification”, “identification of noise sources and automatic generation of countermeasure plans”, and “expansion of online reservation slots for administrative counters” using the generative AI based on the analysis result, and automatically executes routine work in cooperation with a signal control system, a notification distribution system, a public transportation schedule adjustment system, an energy supply and demand adjustment system, an administrative procedure system, and a disaster information distribution system. Specific examples of prompt sentences to be read by the generative AI include “Please propose five optimal city operation policy plans during the event period based on the following city data analysis results”, “Please list countermeasures to be implemented during this power consumption peak”, and “Please generate an optimal evacuation guidance plan during the event”.

The creative city policy generation unit automatically generates new policy plans such as “proposal of an urban agriculture experience program during the event period”, “solution to event garbage problems by garbage collection route optimization by AI”, “peak cutting by citizen-participatory energy sharing”, “safety and comfort improvement by IoT implementation in parks”, and “congestion status grasping by drone utilization during the event” using the generative AI, and proposes the plans to the city manager. Specific examples of prompt sentences to be read by the generative AI include “Please generate 10 new policy plans for the sustainable development of the city during the event period”, “Please list creative ideas for improving resident services”, and “Please propose a city design plan that balances the event and the city landscape”.

The user interface unit is configured so that the city manager can check the latest city data summarization, recommended decision-making plans, ongoing business efficiency improvement tasks, hints for creativity improvement, complaints and requests from residents, approval status of policy plans, and the like at a glance on a dashboard screen, and also enables comment and feedback input for report content, sharing with related departments, automatic generation of new tasks and meetings based on the report content, and the like. Specifically, this system activates a dedicated event mode process to process peculiar city dynamics during the event. This city data collection unit increases a polling frequency of a sensor group around the event venue to ten times that of a normal time. This city data collection unit captures WiFi probe requests of smartphones emitted by tens of thousands of visitors in real time as spatial tensor data. This city data analysis unit models a movement trajectory of a crowd as a network of nodes and edges using a graph neural network. This city data analysis unit receives a density distribution matrix of the crowd and a vehicle speed vector of surrounding roads as input data. This city data analysis unit outputs a bottleneck occurrence probability at a specific gate after 30 minutes as a percentage as output data. This city operation support unit calculates an optimal solution for crowd guidance using a reinforcement learning algorithm. This city operation support unit outputs a control signal for switching display content of digital signage as output data. This city operation support unit outputs a command for dynamically extending a green light cycle of traffic lights around the venue as output data. This creative city policy generation unit receives a sentiment analysis result of SNS indicating a degree of enthusiasm for the event as input data. This creative city policy generation unit outputs structured data of a new policy such as “additional implementation of projection mapping utilizing surplus power” as output data. This user interface unit superimposes and displays these prediction results and policy plans on a three-dimensional event venue map like a hologram. This system broadcasts control commands to each infrastructure facility all at once triggered by an approval operation of the user. This system executes fine-tuning of a model using all data collected after the end of the event as training data. This system thereby maximizes a dynamic adaptation capability of city infrastructure to sudden demand fluctuations. This system brings about a technical effect of preventing congestion accidents during the event. This system is applied to operation management of international sports tournaments and large-scale outdoor music festivals.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL:https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

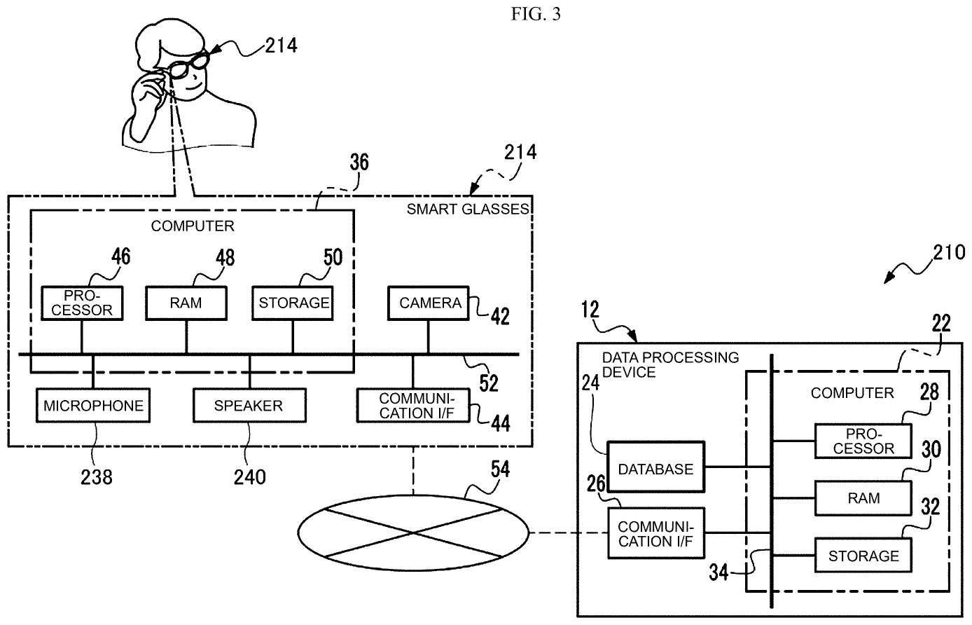

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

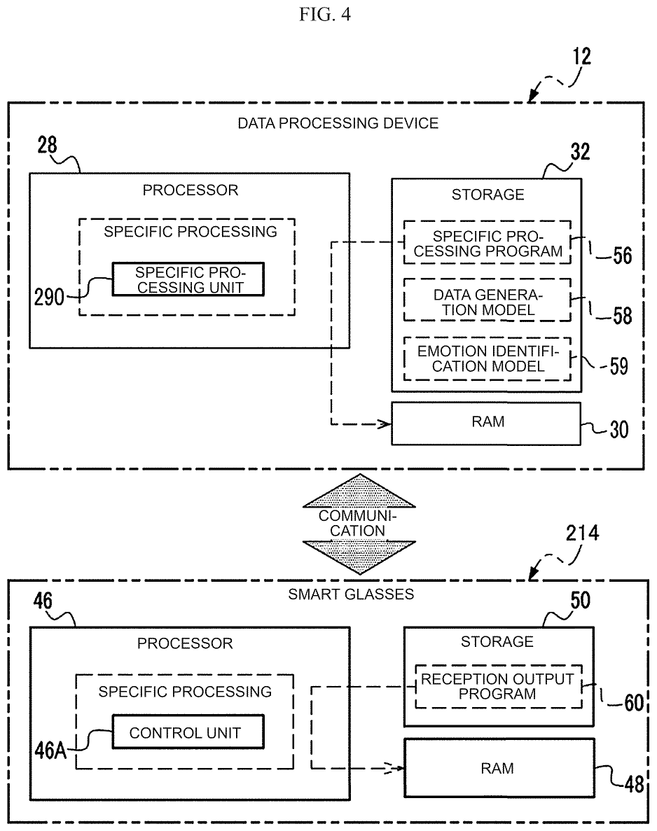

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### EXAMPLE 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### THIRD EMBODIMENT

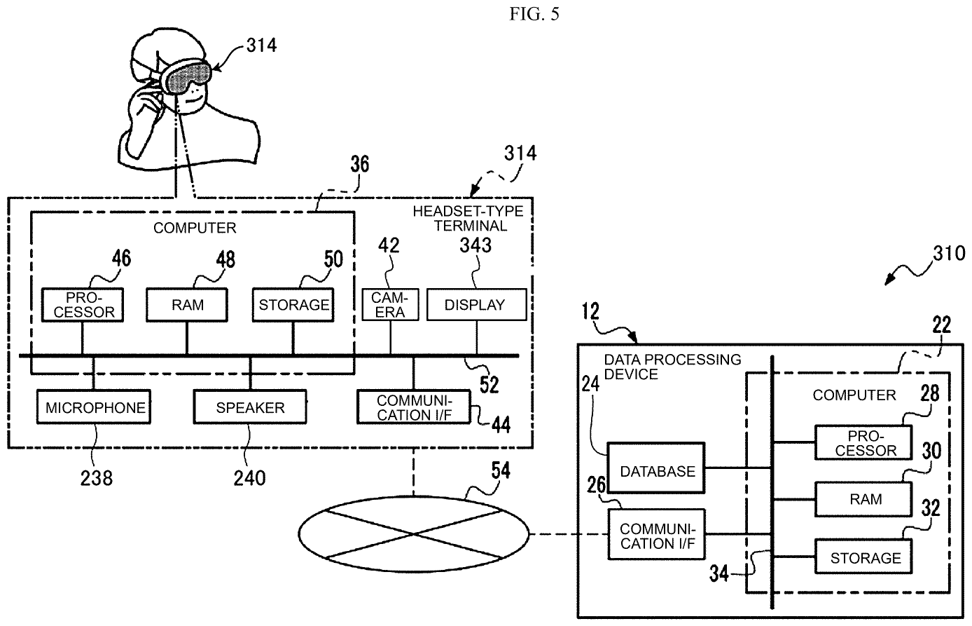

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

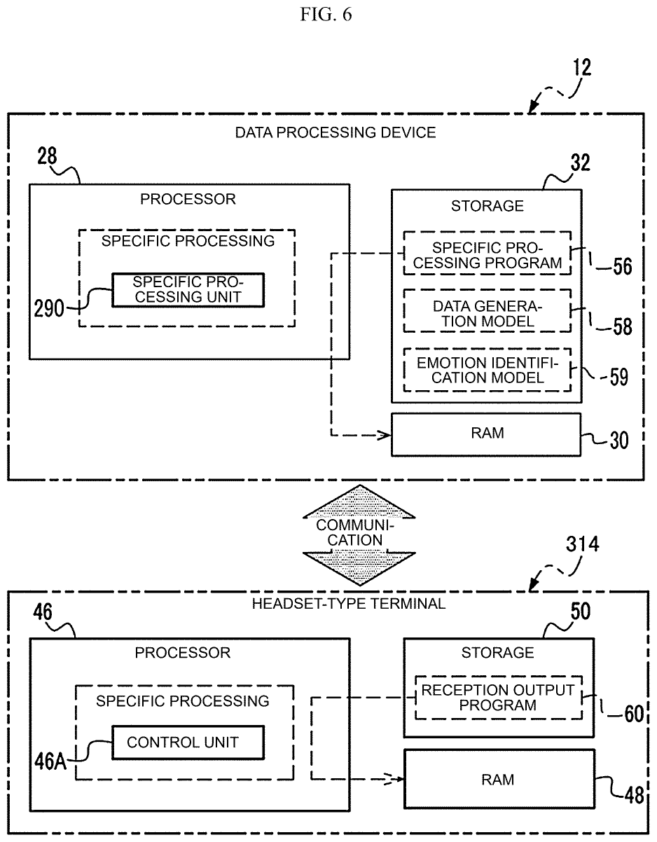

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### FOURTH EMBODIMENT

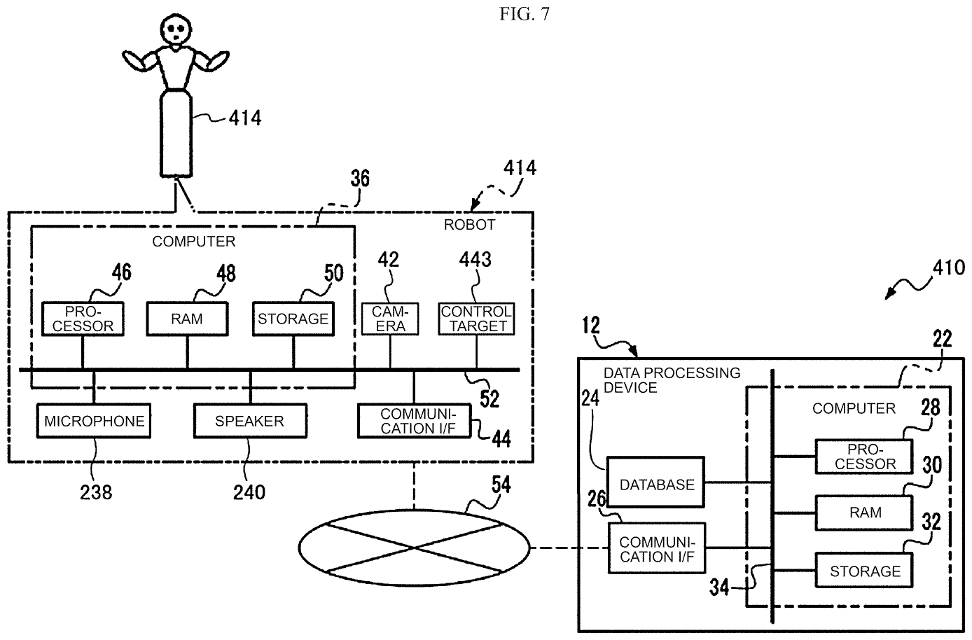

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

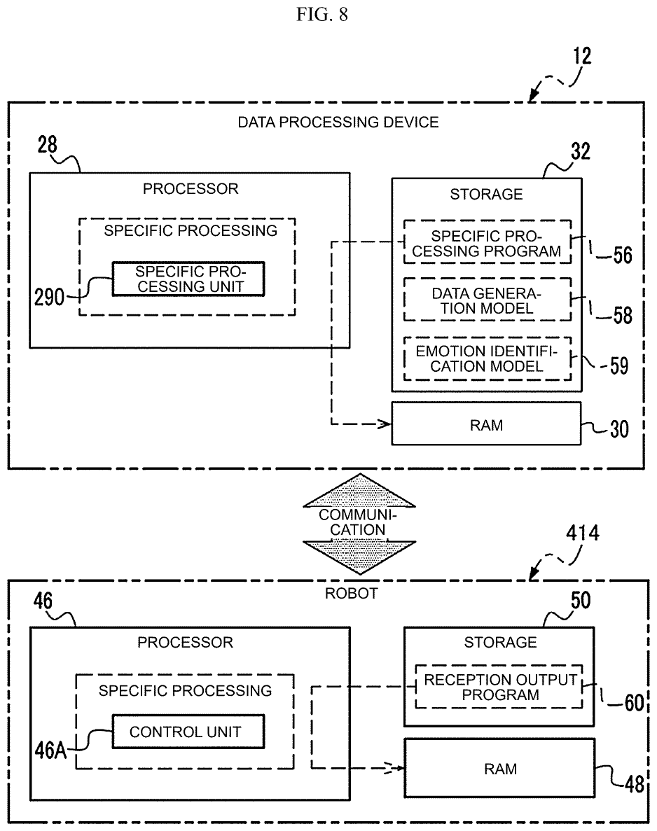

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.” (Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

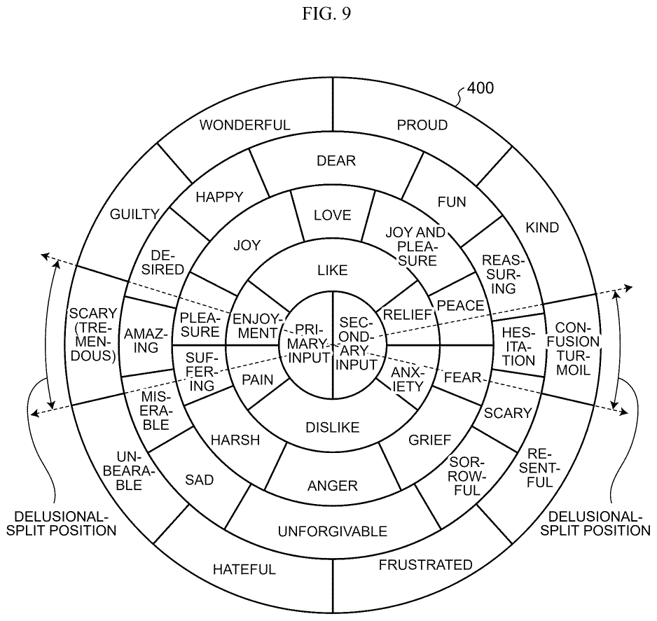

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

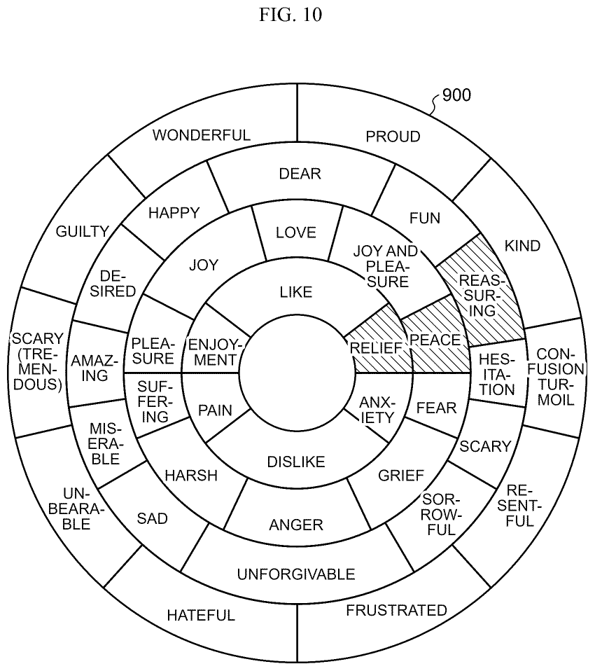

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A smart city integrated operation support system comprising: a city data collection unit; a city data analysis unit; a city operation support unit; and a creative city policy generation unit, wherein the city data collection unit has a function of automatically and cross-sectionally collecting data related to city operation, such as traffic conditions, energy consumption, environmental indicators, disaster prevention-related information, administrative service usage status, and complaints and requests from residents, in real time from various external and internal information sources such as a traffic sensor, a public transportation operation API, an energy infrastructure API, an environmental IoT sensor, a weather API, a disaster prevention information API, an administrative system API, a resident feedback application, and an SNS public information API, centrally storing the collected data in a database on a server, and automatically performing deduplication and metadata addition; the city data analysis unit has a function of applying natural language processing and an anomaly detection algorithm using a generative AI to a vast amount of city data acquired by the city data collection unit, automatically executing summarization of various data, anomaly value detection, trend analysis, risk evaluation, resident needs extraction, and the like, and automatically generating an analysis result in a visual format such as text, a graph, a chart, a heat map, and a word cloud; the city operation support unit has a function of automatically generating an optimal policy plan necessary for city operation, such as signal control optimization during traffic congestion, public transportation schedule adjustment, power saving request notification during an energy consumption peak, automatic transmission of evacuation information during a disaster, and expansion of online reservation slots during administrative counter congestion, using the generative AI based on an output result of the city data analysis unit, and further automatically executing routine work in cooperation with a signal control system, a notification distribution system, an administrative procedure system, and the like; the creative city policy generation unit has a function of automatically generating a new and creative city policy plan, such as promotion of urban agriculture, garbage collection route optimization by AI, citizen-participatory energy sharing, IoT implementation in parks, and drone utilization during a disaster, using the generative AI, and proposing the plan to a city manager; and these units operate in cooperation with each other to automatically generate and provide to the city manager and related departments a city operation report integrating summarization, analysis, decision-making support, business automation, and creative policy proposal related to city operation.

### (Supplementary Note 2)

The system according to Supplementary Note 1, wherein the city data analysis unit includes processing of automatically classifying various city data such as traffic, energy, environment, disaster prevention, administration, and resident feedback using the generative AI, selecting and applying an optimal summarization algorithm or anomaly detection method for each category, and further automatically generating the analysis result in a plurality of visual formats such as a time-series graph, a heat map, and a word cloud so that the city manager can grasp a situation and a risk of the entire city in a short time.

### (Supplementary Note 3)

The system according to Supplementary Note 1, wherein the city operation support unit includes processing of automatically executing routine work of city operation, such as automatic optimization of signal control upon detection of traffic congestion, automatic distribution of a power saving request notification during an energy consumption peak, automatic transmission of evacuation information upon occurrence of a disaster risk, automatic expansion of online reservation slots during administrative counter congestion, and automatic improvement proposal of an administrative service based on complaints and requests from residents, using the generative AI, and notifying the city manager of progress and a result of these business efficiency improvement processes in real time.

What is claimed is:

1. A system comprising:
circuitry configured to:
receive, via a communication interface coupled to a packet-switched network, multidimensional time-series telemetry data from a plurality of sensor nodes distributed across a physical environment, perform noise removal and data compression at edge computing nodes, and transmit normalized data streams to a cloud computing node via the communication interface;
write the normalized data streams to an in-memory database, apply a generative neural network model to the integrated normalized data streams to generate an analysis result data record comprising trend feature vectors, anomaly indicators, and risk evaluation scores;
apply a decision support model to the analysis result data record and historical case data retrieved from a vector database to generate a ranked option data record comprising candidate decision sequences with associated risk scores and comparative evaluation data;
apply an automation pipeline to routine task data records received from a terminal device by generating output documents comprising structured text data for each detected task type using the generative neural network model; and
transmit the analysis result data record, the ranked option data record, and the generated output documents to terminal devices via the communication interface.

2. The system according to claim 1, wherein the circuitry is configured to receive integer count data and floating-point environmental parameter data from sensor nodes at predetermined collection intervals, apply a noise removal filter and a data compression algorithm at edge computing nodes, and transmit compressed feature vectors as normalized data streams to the in-memory database in the cloud computing node.

3. The system according to claim 2, wherein the circuitry is configured to apply an in-memory stream processing engine to the normalized data streams to aggregate telemetry values at configurable time intervals, flag data values deviating from expected ranges with anomaly value flags, and route flagged records to an anomaly analysis pipeline.

4. The system according to claim 1, wherein the circuitry is configured to apply a natural language processing model with keyword extraction to query data received from a terminal device, issue retrieval requests to a plurality of external data service endpoints and internal data repositories via the communication interface based on extracted keywords, and store retrieved records in the storage device as a consolidated information record set.

5. The system according to claim 4, wherein the circuitry is configured to apply the generative neural network model to the consolidated information record set to generate an analysis result comprising automatic summarization text, keyword frequency vectors, trend direction indicators, and risk evaluation scores, and format the analysis result data record as a structured output for transmission to the terminal device.

6. The system according to claim 1, wherein the circuitry is configured to apply the decision support model to the ranked option data record by computing a risk score for each candidate decision sequence using a weighted combination of historical outcome data retrieved from the vector database and current trend feature vectors, and generating justification text for each candidate decision sequence by autoregressive decoding.

7. The system according to claim 6, wherein the circuitry is configured to retrieve historical case data from the vector database by computing cosine similarity scores between a query embedding vector derived from the analysis result data record and stored case record embedding vectors, and incorporate the top-ranked retrieved case records as reference context in the decision support model prompt.

8. The system according to claim 1, wherein the circuitry is configured to detect a task type identifier from routine task data records received from the terminal device using a task classification model, route each task data record to a corresponding automated generation pipeline, and generate structured output documents comprising agenda text, action item lists, and scheduling data by applying the generative neural network model.

9. The system according to claim 8, wherein the circuitry is configured to receive audio waveform data from the terminal device via the communication interface, apply a speech recognition model to generate transcript text, apply a natural language processing model to the transcript text to extract key topic segments and decision records, and generate a structured session summary document from the extracted segments.

10. The system according to claim 1, wherein the circuitry is configured to apply a creative generation model to theme specification data received from the terminal device by retrieving analogous reference records from the vector database using cosine similarity search, and generating novel conceptual proposal text by conditioning the generative neural network model on the retrieved reference records and the theme specification data.

11. The system according to claim 1, wherein the circuitry is configured to generate a scenario simulation output by applying the generative neural network model to the analysis result data record conditioned on a plurality of hypothetical condition parameter sets, and transmit comparative scenario outcome data comprising predicted state values for each hypothetical condition to the terminal device.

12. The system according to claim 1, wherein the circuitry is configured to monitor key metric values in the normalized data streams against configurable threshold parameters, generate an alert data record when a metric value crosses a threshold, apply the generative neural network model to the alert data record to generate a recommended response action sequence, and transmit the alert data record and response action sequence to terminal devices associated with administrative user identifiers.

13. The system according to claim 1, wherein the circuitry is configured to store all analysis result data records, ranked option data records, and generated output documents in an audit log data structure with timestamps and user identifiers, and generate periodic summary reports from the audit log data structure for transmission to terminal devices.

14. The system according to claim 1, wherein the circuitry is configured to update the generative neural network model by generating training pairs from historical analysis result data records and corresponding validated decision outcome records, and fine-tune the model to improve risk score prediction accuracy and decision sequence relevance.

15. The system according to claim 1, wherein the circuitry is configured to distribute incoming telemetry data processing tasks across a plurality of edge computing nodes, apply load balancing to assign processing tasks based on available node capacity, and aggregate compressed feature vectors from all edge computing nodes in the cloud computing node for unified analysis.

16. The system according to claim 1, wherein the circuitry is configured to enforce a role-based access control policy by associating data categories in the consolidated information record set with required user role parameters, and restrict retrieval to records within the permission scope of the requesting terminal device user role parameter.

17. The system according to claim 1, wherein the sensor nodes are distributed across a physical environment comprising infrastructure monitoring points, the telemetry data comprises traffic volume count data and environmental parameter data, and the analysis result data record represents operational state assessments of the physical environment.

18. A system comprising:
circuitry configured to:
receive, via a communication interface coupled to a packet-switched network, multidimensional time-series telemetry data from sensor nodes, perform edge computing noise removal and compression, and write normalized data streams to an in-memory database;
apply a generative neural network model to normalized data streams to generate analysis result data records comprising trend feature vectors and risk evaluation scores;
apply a decision support model using historical case data retrieved by cosine similarity from a vector database to generate ranked option data records with risk scores and justification text;
detect task type identifiers from routine task data, apply automated generation pipelines, and generate structured output documents; and
transmit analysis result data records, ranked option data records, and output documents to terminal devices via the communication interface.

19. The system according to claim 18, wherein the circuitry is configured to receive audio waveform data and apply a speech recognition model to generate transcript text, extract key topic segments to generate structured session summary documents, and apply a creative generation model to theme specification data to generate novel conceptual proposals by conditioning on analogous reference records retrieved from a vector database.

20. A method comprising:
receiving, via a communication interface coupled to a packet-switched network, multidimensional time-series telemetry data from sensor nodes, performing noise removal and compression at edge computing nodes, and transmitting normalized data streams to a cloud computing node;
writing the normalized data streams to an in-memory database, and applying a generative neural network model to generate an analysis result data record comprising trend feature vectors, anomaly indicators, and risk evaluation scores;
applying a decision support model to the analysis result data record and historical case data retrieved from a vector database to generate a ranked option data record comprising candidate decision sequences with associated risk scores;
applying an automation pipeline to routine task data records to generate output documents; and
transmitting the analysis result data record, the ranked option data record, and the output documents to terminal devices via the communication interface.
